(19) United States
(12) Patent Application Publication
(10) Pub. No.: US 2002/0049623 A1
(43) Pub. Date: Apr. 25, 2002

(54) System and method for implementing an image-based document handling and delivery system

(76) Inventors: June Dianne Martin, Forest, VA (US); Kelli Rae Martin, Forest, VA (US); Anthony Edward Hashem, Lynchburg, VA (US); Jennifer Dorothy Vecchio, Rustburg, VA (US); Dave Bruce Wood, Goode, VA (US)

Correspondence Address: Jennifer A. Albert, Esq., Hunton & Williams, Suite 1200, 1900 K Street, N.W., Washington, DC, 20006, US

(21) Appl. No.: 09/908,774

(22) Filed: Jul. 20, 2001

Related U.S. Application Data
(63) Continuation-in-part of application No. 09/620,563, filed on Jul. 20, 2000.
(60) Provisional application No. 60/219,693, filed on Jul. 21, 2000.

(51) Int. Cl. G06F 17/60

(52) U.S. Cl. 705/7

(57) ABSTRACT

A system and method for implementing an image-based document handling and delivery system provides a business entity with information and guidance required to convert the entity's current document handling and delivery system and methodology to an image-based document handling and delivery system and methodology. The system and method of the present invention uses a planning component, an execution component, and a control component. The planning component gathers information about the business entity's infrastructure and the business entity's current paper-based document handling and delivery system and methodology. The implementation component provides the business entity with process maps that provide step-by-step instructions for executing the image-based system and methodology. The control component provides the business entity with guidelines and procedures for monitoring and maintaining the performance of the executed image-based system and methodology.

### CROSS REFERENCES TO RELATED APPLICATIONS

This patent application is a continuation-in-part of U.S. patent application Ser. No. 09/620,563, filed Jul. 20, 2000, which is hereby incorporated by reference herein in its entirety.

This patent application is related to copending U.S. Provisional Patent Application No. 60/219,693, filed Jul. 21, 2000, which is hereby incorporated by reference herein in its entirety.

### FIELD OF THE INVENTION

This invention relates to document handling and delivery systems and, more specifically, to a system and method for implementing an image-based document handling and delivery system.

### BACKGROUND OF THE INVENTION

Businesses typically use traditional paper-based document handling and delivery systems. The most common traditional paper-based document delivery systems are government and private mail delivery services.

Many businesses would benefit from a true “image-based” document handling and delivery system in which a paper document is converted to an electronic image and, once the paper document is converted to an image (e.g., converted to an image file with a scanner or similar equipment), the converted document is transmitted and manipulated electronically in image form without having to convert the document back to paper. However, many businesses are reluctant to convert to an image-based document handling and delivery system because of the complexities involved. For these businesses, their entire infrastructures and methodologies for handling documents from customers utilize paper-based systems, and it is often not clear how those methodologies and infrastructures would need to change to implement image-based systems. Thus, such businesses have a need for information and guidance to assist them in converting their paper-based infrastructures and methodologies connected with their document handling and delivery systems to image-based systems.

### BRIEF SUMMARY OF THE INVENTION

In view of the above problems in the art, the present invention provides a system and method for implementing an image-based document handling and delivery system. The system and method of the present invention provides a business entity with information and guidance required to convert its current paper-based document handling and delivery system to an image-based system.

An image-based document handling and delivery system (Imaging System) may offer many advantages over traditional paper-based document handling and delivery systems, including, but not limited to: (1) improved business cycle time because time-consuming traditional mail/courier services are no longer used or are used less frequently; (2) reduced mail/courier costs; (3) fewer resources needed to open/sort/deliver mail internally; and (4) fewer lost files.

Additional advantages of the invention will be set forth in part in the description which follows, and in part will be obvious from the description, or may be learned by practice of the invention. The advantages of the invention, may be realized and attained by means of the instrumentalities and combinations particularly pointed out in the appended claims.

The present invention relates to a system for implementing an image-based document handling and delivery system. The system comprises a planning component, an execution component, and a control component. The planning component gathers information about an infrastructure, a current document handling and delivery system and a methodology used by an entity. The implementation component provides the entity with a plurality of process maps that provide a plurality of step-by-step instructions for executing the image-based document handling and delivery system. The control component provides the entity with a plurality of contingency guidelines and procedures for monitoring and maintaining performance of the executed image-based document handling and delivery system, wherein the procedures for monitoring and maintaining performance of the executed image-based document handling and delivery system include quality review procedures.

In another aspect, the invention includes a system for implementing an image-based document handling and delivery system. The system comprises a planning component that gathers information about an infrastructure, a current document handling and delivery system and a methodology used by an entity; an implementation component that provides the entity with a plurality of process maps that provide a plurality of step-by-step instructions for executing the image-based document handling and delivery system; and a control component that provides the entity with a plurality of contingency guidelines and procedures for monitoring and maintaining performance of the executed image-based document handling and delivery system; wherein the process maps of the implementation component include at least one of a document specific process map dependent on a location of the document to be processed.

In yet another aspect, the invention includes a method of implementing an image-based document handling and delivery system. The method comprises the steps of gathering information about an entity's existing document handling and delivery system; providing the entity with at least one process map for executing the image-based document handling and delivery system; and providing the entity with a plurality of guidelines and procedures for monitoring and maintaining performance of the image-based document handling and delivery system; wherein the step of providing the entity with at least one process map includes providing one of a document specific process map dependent on a type of document being processed and a location specific process map dependent on a location where the document is being processed.

In still another aspect, the invention includes a method of implementing an image-based document handling and delivery system. The method comprises the steps of gathering information about an entity's existing document handling and delivery system; providing the entity with at least one process map for executing the image-based document handling and delivery system; and providing the entity with a plurality of guidelines and procedures for monitoring and maintaining performance of the image-based document handling and delivery system; wherein the step of providing the entity with the guidelines and procedures for monitoring and maintaining performance of the image-based document handling and delivery system includes providing a plurality of quality review procedures.

In still an additional aspect, the invention includes means for implementing an image-based document handling and delivery system. The means comprises means for gathering information about an entity's existing document handling and delivery system; means for providing the entity with at least one process map for executing the image-based document handling and delivery system; and means for providing the entity with a plurality of guidelines and procedures for monitoring and maintaining performance of the image-based document handling and delivery system; wherein the means for providing the at least one process map includes means for providing one of a document specific process map dependent on a type of document being processed and a location specific process map dependent on a location where the document is being processed.

In another aspect, the invention includes means for implementing an image-based document handling and delivery system, comprising the steps of gathering information about an entity's existing document handling and delivery system; providing the entity with at least one process map for executing the image-based document handling and delivery system; and providing the entity with a plurality of guidelines and procedures for monitoring and maintaining performance of the image-based document handling and delivery system; wherein the step of providing the procedures for monitoring and maintaining performance of the executed image-based document handling and delivery system includes providing a plurality of quality review procedures.

In yet another aspect, the invention includes a computer readable medium, the computer readable medium storing computer readable code executable to perform a method for implementing an image-based document handling and delivery system, the method comprising the steps of gathering information about an entity's existing document handling and delivery system; providing the entity with at least one process map for executing the image-based document handling and delivery system; and providing the entity with a plurality of guidelines and procedures for monitoring and maintaining performance of the image-based document handling and delivery system; wherein the step of providing the entity with at least one process map includes providing one of a document specific process map dependent on a type of document being processed and a location specific process map dependent on a location where the document is being processed.

And, in yet another aspect, the invention includes a computer readable medium, the computer readable medium storing computer readable code executable to perform a method for implementing an image-based document handling and delivery system, the method comprising the steps of gathering information about an entity's existing document handling and delivery system; providing the entity with at least one process map for executing the image-based document handling and delivery system; and providing the entity with a plurality of guidelines and procedures for monitoring and maintaining performance of the image-based document handling and delivery system; wherein the step of providing the entity with the plurality of guidelines and procedures for monitoring and maintaining performance of the executed image-based document handling and delivery system includes providing a plurality of quality review procedures.

The accompanying drawings, which are incorporated in and constitute a part of this specification, illustrate the embodiments of the invention and, together with the description, serve to explain the principles of the invention.

### BRIEF DESCRIPTION OF THE DRAWINGS

Embodiments of this invention will be described in detail, with reference to the following figures, wherein:

FIG. 1 is a block diagram of a system for implementing an image-based document handling and delivery system, in accordance with an embodiment of the present invention;

FIG. 2 is a block diagram of a planning component, in accordance with an embodiment of the present invention;

FIGS. 3A-3E show a survey used by the planning component and designed for an insurance industry entity, in accordance an embodiment of with the present invention;

FIG. 4 is a block diagram of a preferred implementation component, in accordance with an embodiment of the present invention;

FIGS. 5A-5F are sample process maps used by the implementation component and designed for an insurance industry entity, in accordance with an embodiment of the present invention;

FIG. 6 illustrates a sample process map for a process for receiving and forwarding mail in the mail and copy room of FIGS. 5A-5F;

FIGS. 7A-7C illustrate sample process maps for processing mail in the sales team 220 of FIGS. 5A-5F;

FIGS. 8A-8E illustrate sample process maps for the branch team 240 of FIGS. 5A-5F;

FIGS. 9A-9E illustrate sample process maps for processes in the imaging team 250 after the Imaging System has been implemented;

FIGS. 10A-10D show a table of document types used by the implementation component and designed for an insurance industry entity, in accordance with an embodiment of the present invention;

FIG. 11 is a block diagram of a control component, in accordance with an embodiment of the present invention;

FIG. 12 is a block diagram of contingency guidelines, in accordance with an embodiment of the present invention;

FIGS. 13A-13D show a table of error resolution guidelines used by the control component and designed for an insurance industry entity, in accordance with an embodiment of the present invention;

FIGS. 14A-14G show a failure modes effects analysis table used by the control component and designed for an insurance industry entity, in accordance with an embodiment of the present invention;

FIGS. 15A-15E illustrate sample forms for implementing quality review procedures;

FIG. 16 is a flowchart of steps performed in a method of implementing an image-based document handling and delivery system, in accordance with an embodiment of the present invention; and

FIG. 17 is flowchart of steps performed in a method of implementing the step of providing performance reports to the entity in FIG. 16.

### DETAILED DESCRIPTION OF THE INVENTION

An image-based document handling and delivery system can be particularly advantageous to a business entity that has to process and send many different types of documents. For example, the insurance industry is one industry for which an image-based document handling and delivery system is particularly well-suited. Thus, the present invention will be described in the context of an insurance broker or agent that wishes to send image-based documentation to an insurance provider. However, it should be appreciated that the present invention is applicable to any entity which would like to implement an image-based document handling and delivery system.

In the insurance industry, information about an insured party is typically collected by having the insured party complete a plurality of standardized paper forms. In many instances, the insured party must also provide supporting paper documentation, e.g., an Attending Physician's Statement (APS) to support a claim under a health insurance policy for reimbursement of medical expenses paid by the insured party to the attending physician. For entities in the insurance industry, an image-based document handling and delivery system can reduce the time it takes to process an insurance application or claim, can reduce a number of lost documents, and can reduce the insurance provider's processing costs.

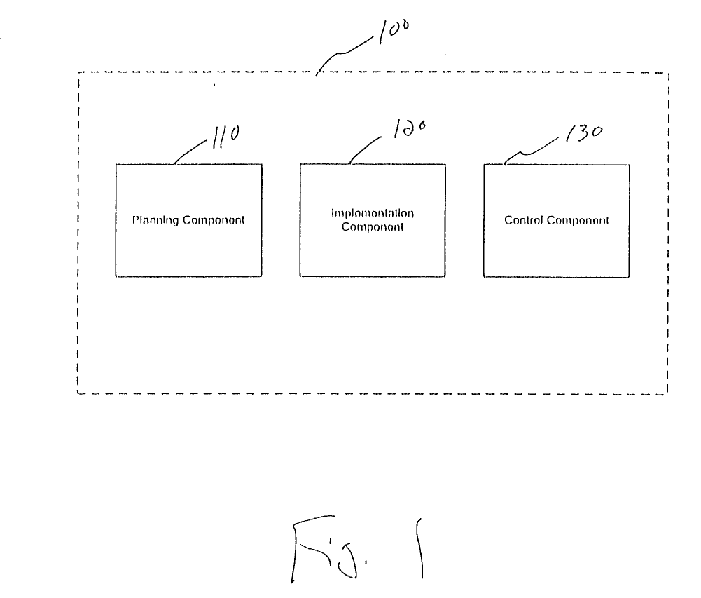

FIG. 1 is a block diagram of a system 100 for implementing an image-based document handling and delivery system (the “Imaging System”), in accordance with an embodiment of the present invention. The system 100 comprises a planning component 110, an implementation component 120, and a control component 130. The planning component 110 gathers information about an entity's infrastructure and its current paper-based document handling and delivery system and methodology. The planning component 110 may also provide the entity with information about the Imaging System.

The implementation component 120 provides the entity with a plurality of process maps that provide a plurality of step-by-step instructions for executing the Imaging System. In addition, the implementation component 120 can optionally provide a plurality of process maps that detail how imaged documents will be handled when they arrive at a destination. The implementation component 120 also preferably provides the entity with a plurality of process maps that outline the entity's current document handling and delivery system, so that the entity can compare its current paper-based document handling and delivery system to the Imaging System. The control component 130 provides the entity with a plurality of guidelines and procedures for monitoring and maintaining performance of the executed Imaging System.

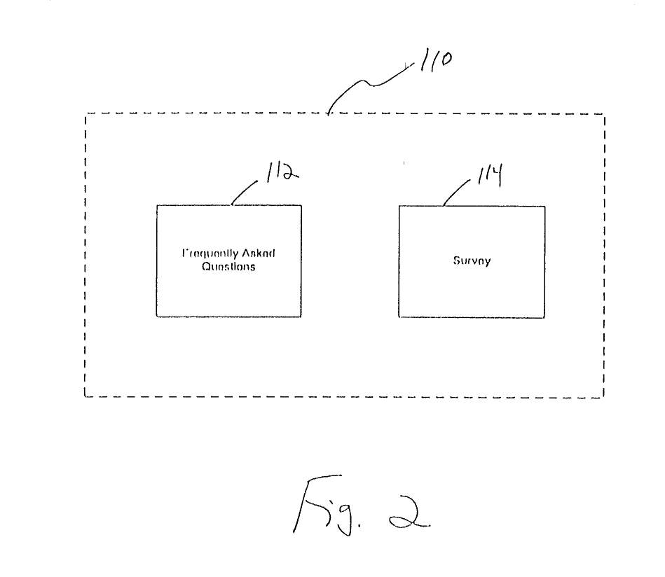

As shown in FIG. 2, the planning component 110 comprises a list of frequently asked questions (FAQs) 112 and a survey (questionnaire) 114 for the entity to complete. The FAQs 112 provide the entity with an answer to each one of a plurality of common questions that business entities have concerning conversion from a paper-based document handling and delivery system to an Imaging System. Sample FAQs for an insurance industry entity are shown below, at the end of the description of FIG. 17.

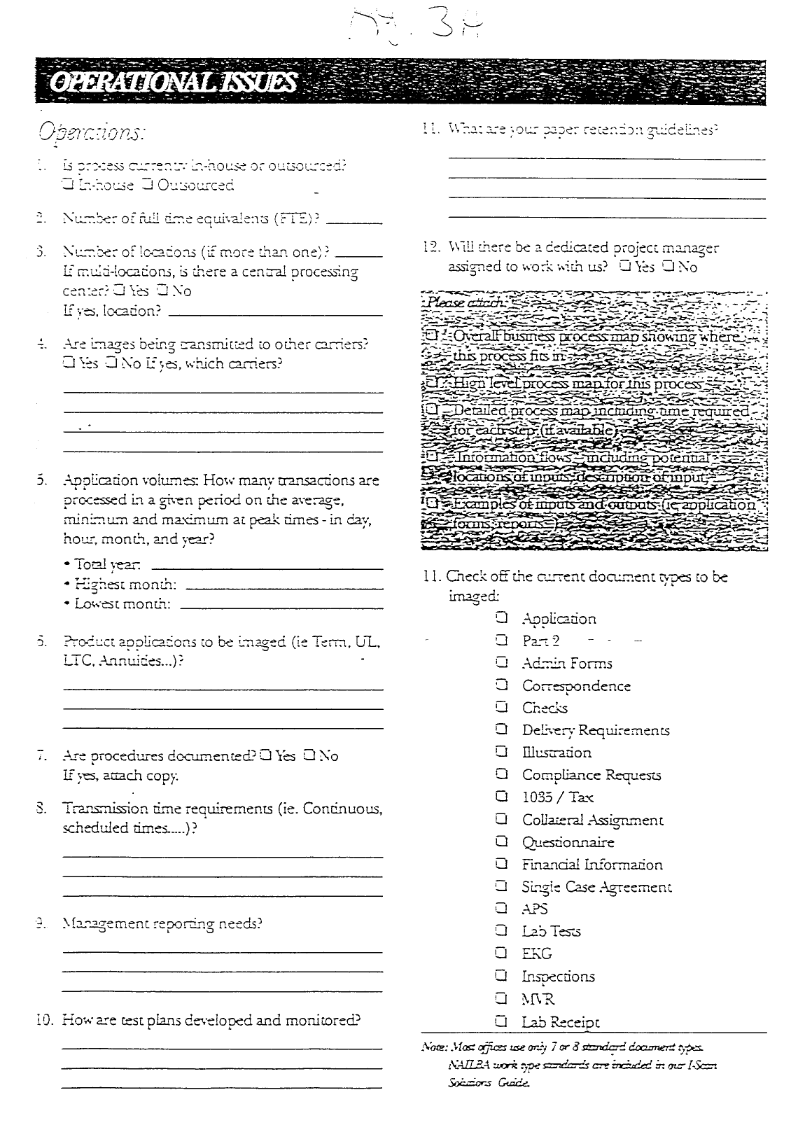

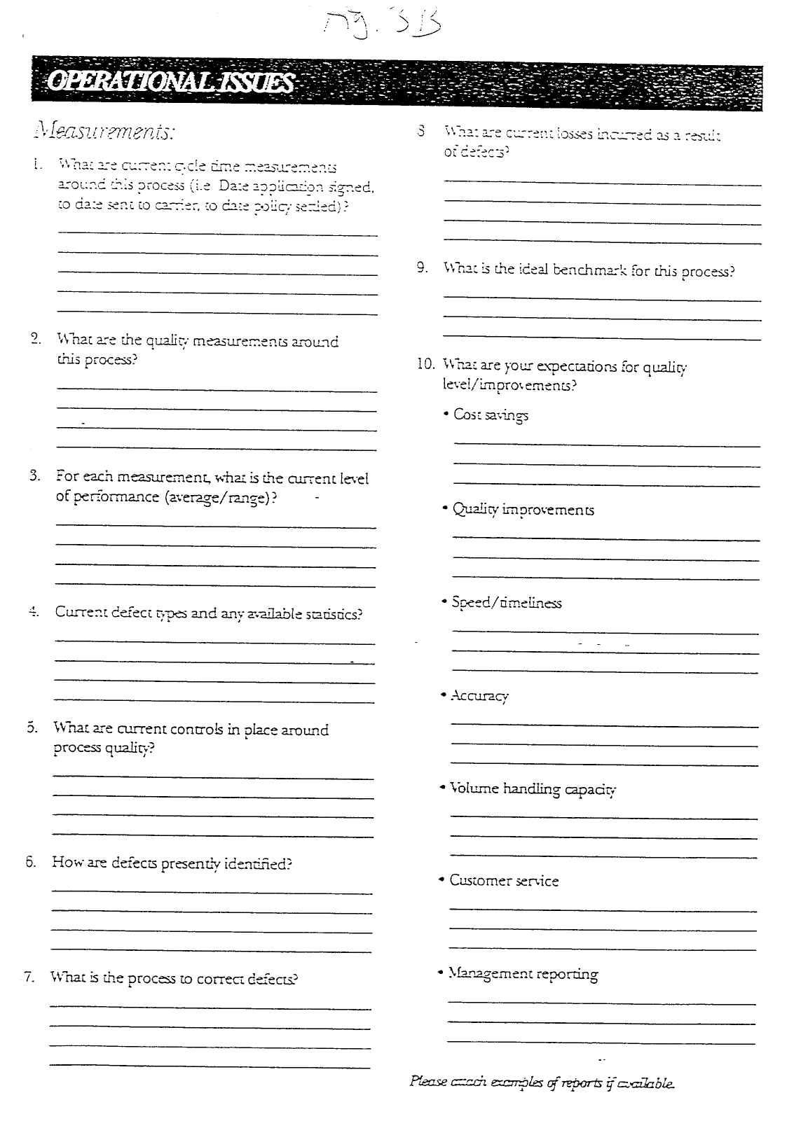

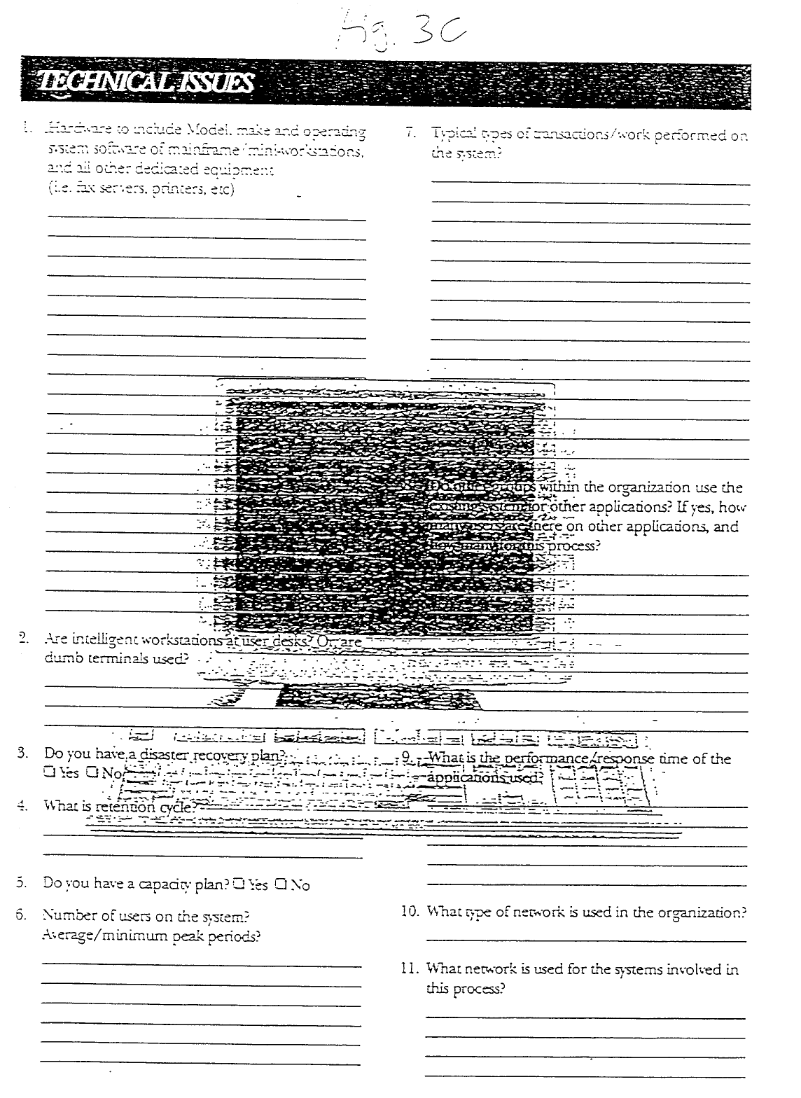

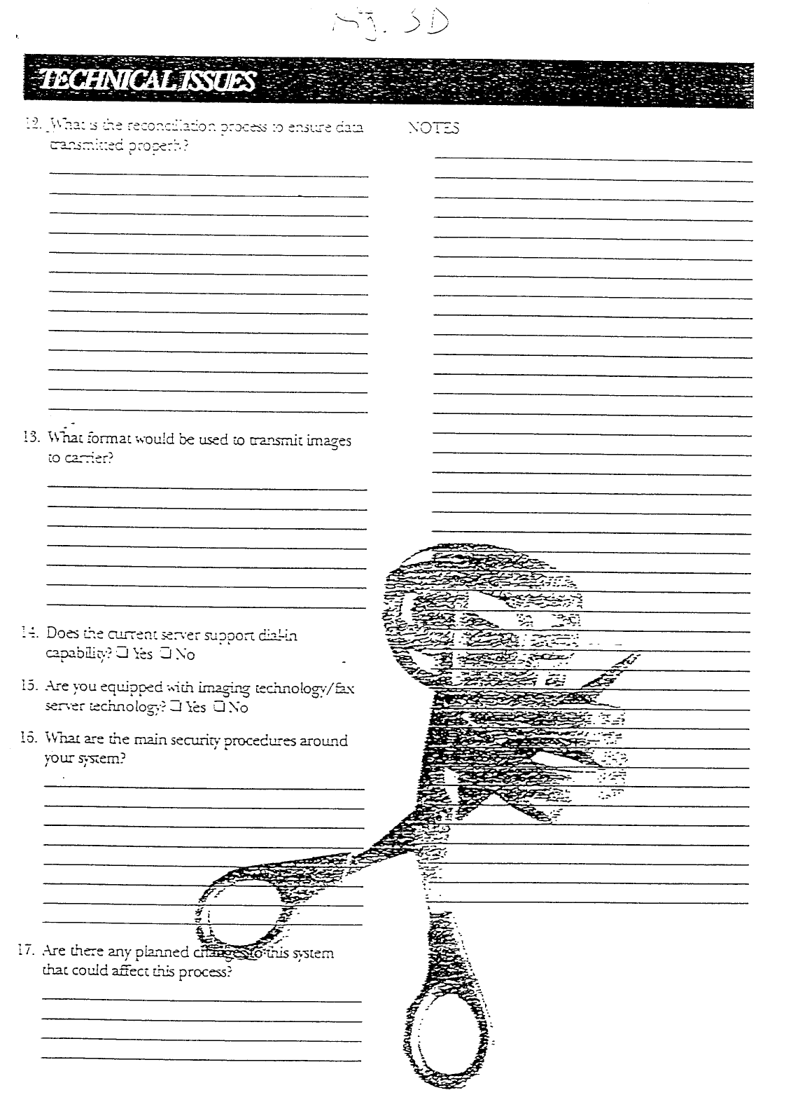

An example survey 114 for an insurance industry entity is shown in FIGS. 3A-3E. The survey 114 may include a plurality of questions dealing with a plurality of operational issues, including, for example, types of documents to be imaged, number of facilities for the entity, a contact person for the entity, an anticipated volume of documents to be imaged and other similar issues (FIGS. 3A and 3B), a plurality of questions dealing with a plurality of technical issues, including, for example, a description of hardware currently used by the entity, a type of network currently used by the entity, a format to be used to transmit imaged documents, and other similar issues (FIGS. 3C and 3D), and a contact list (FIG. 3E).

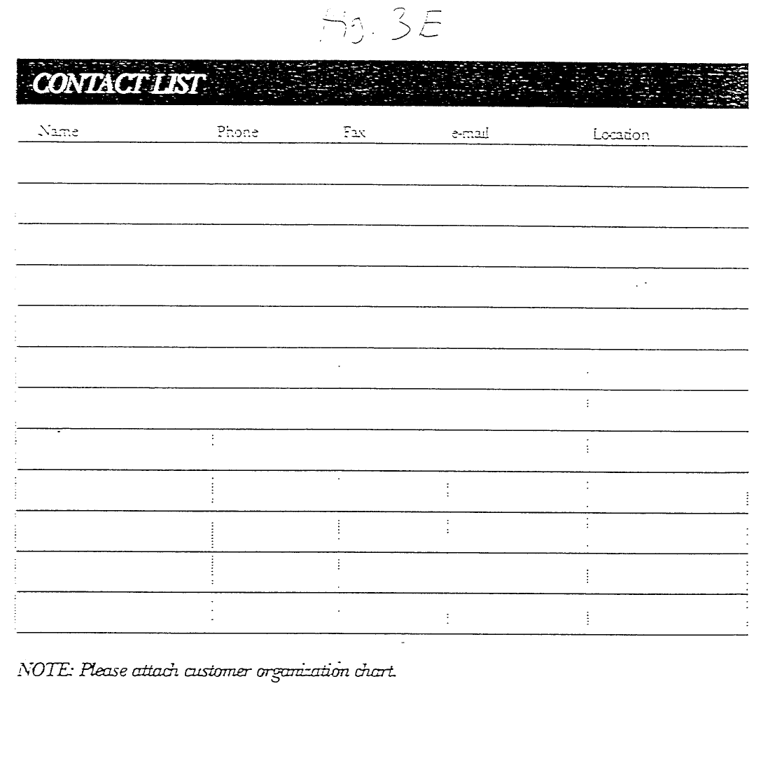

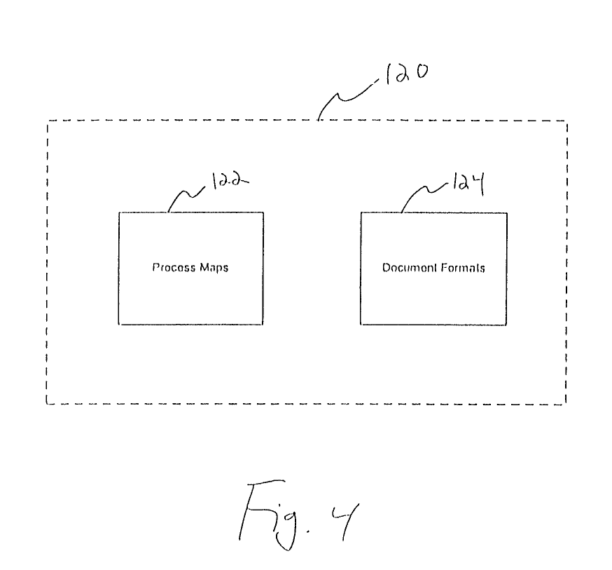

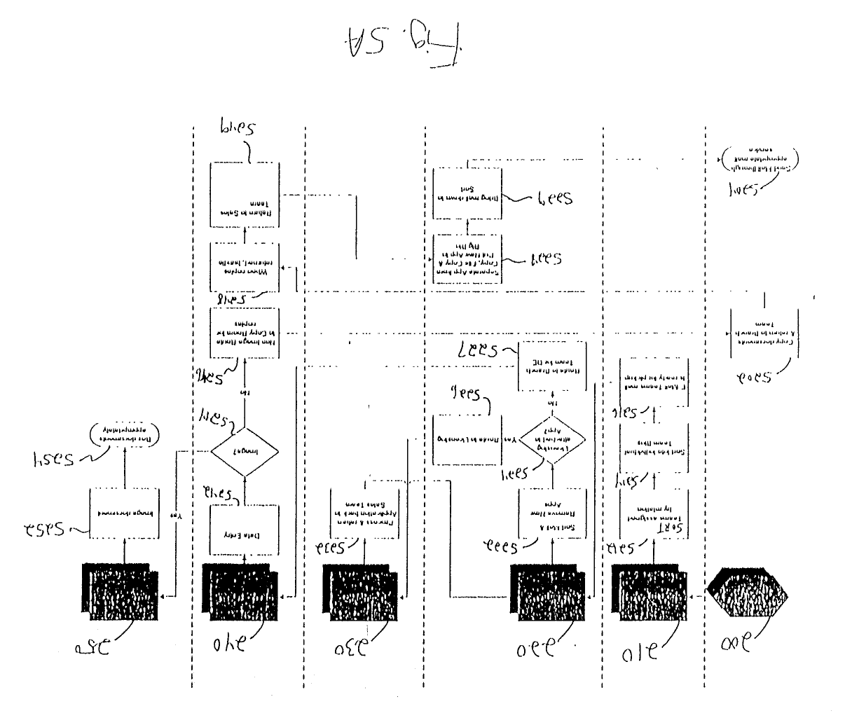

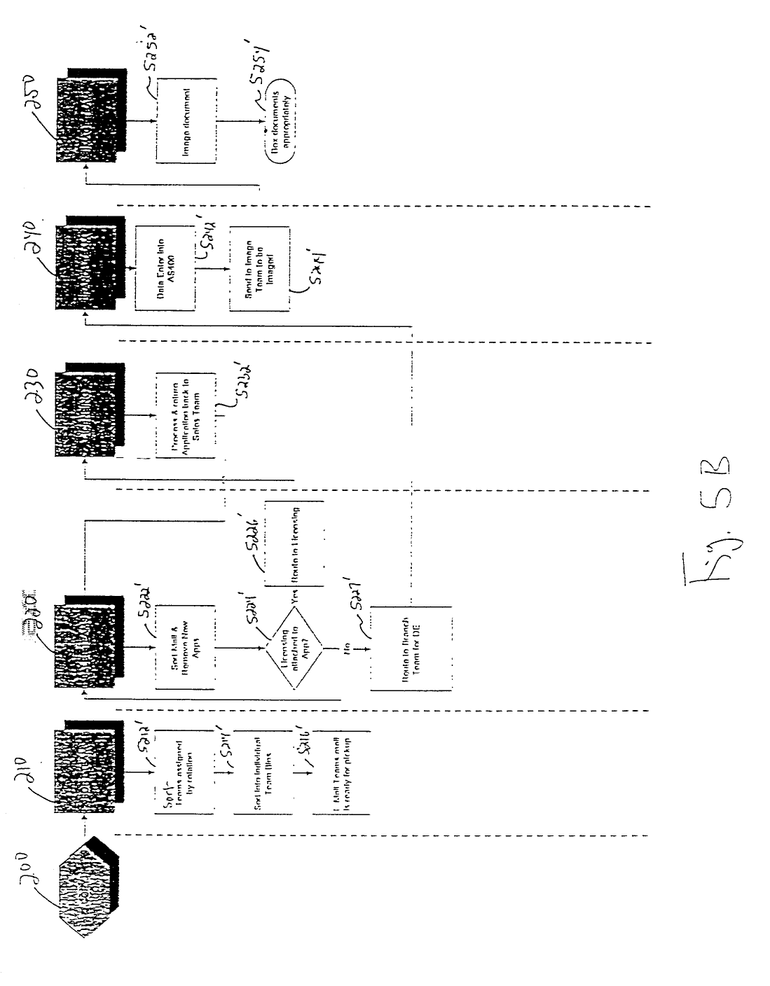

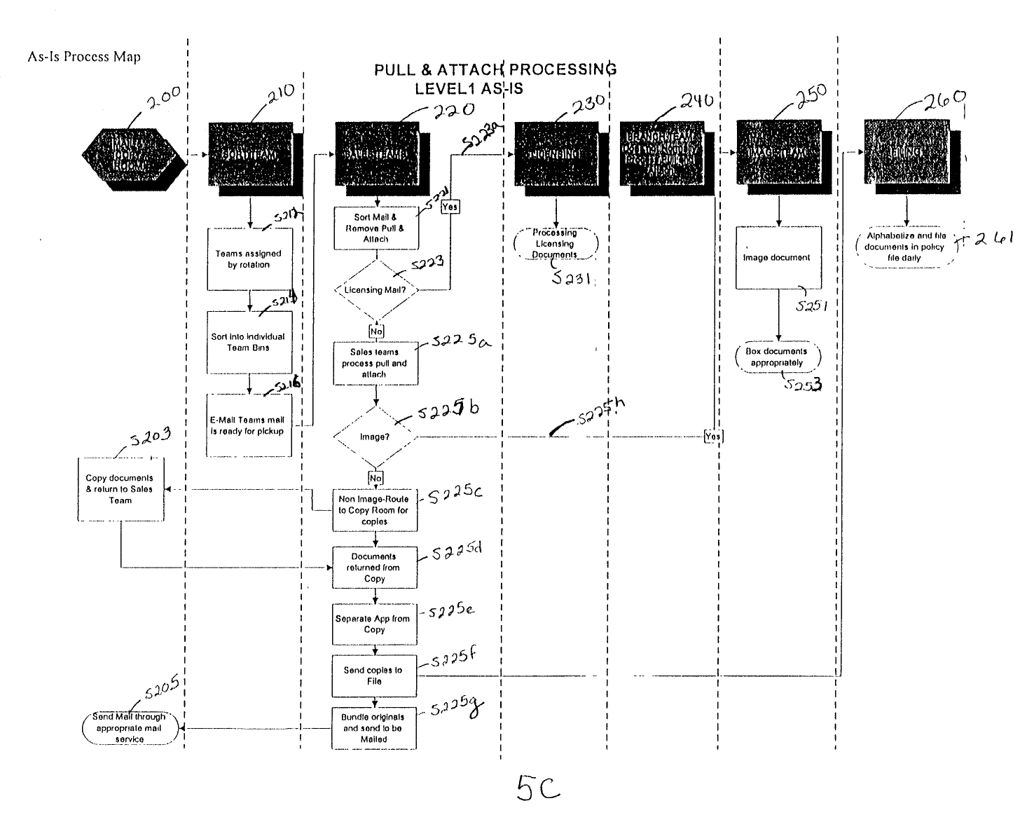

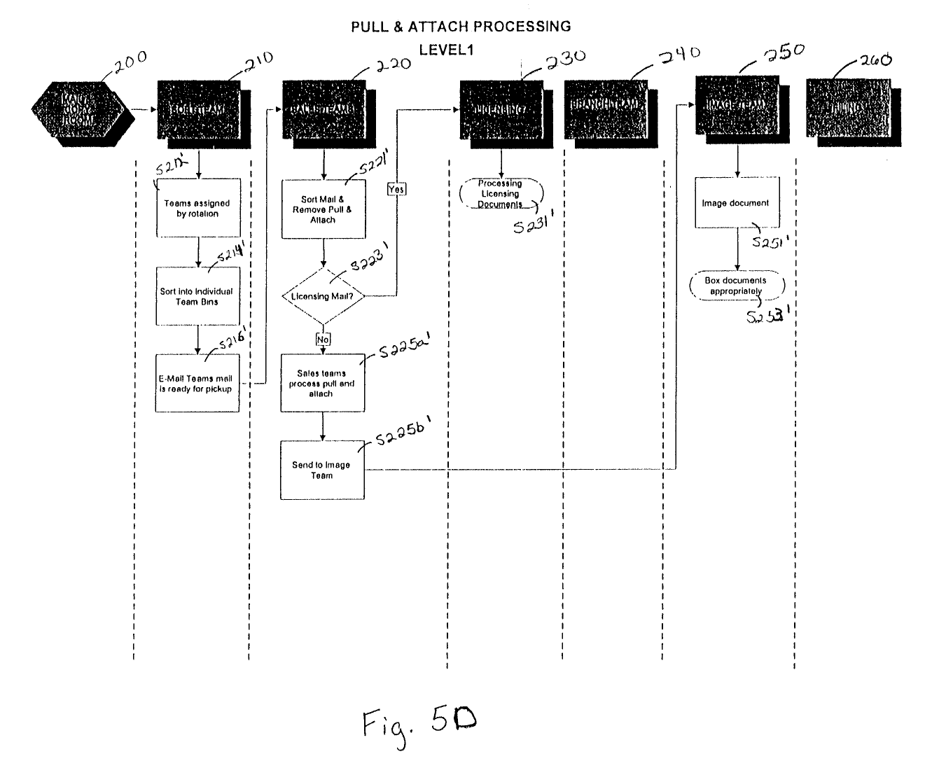

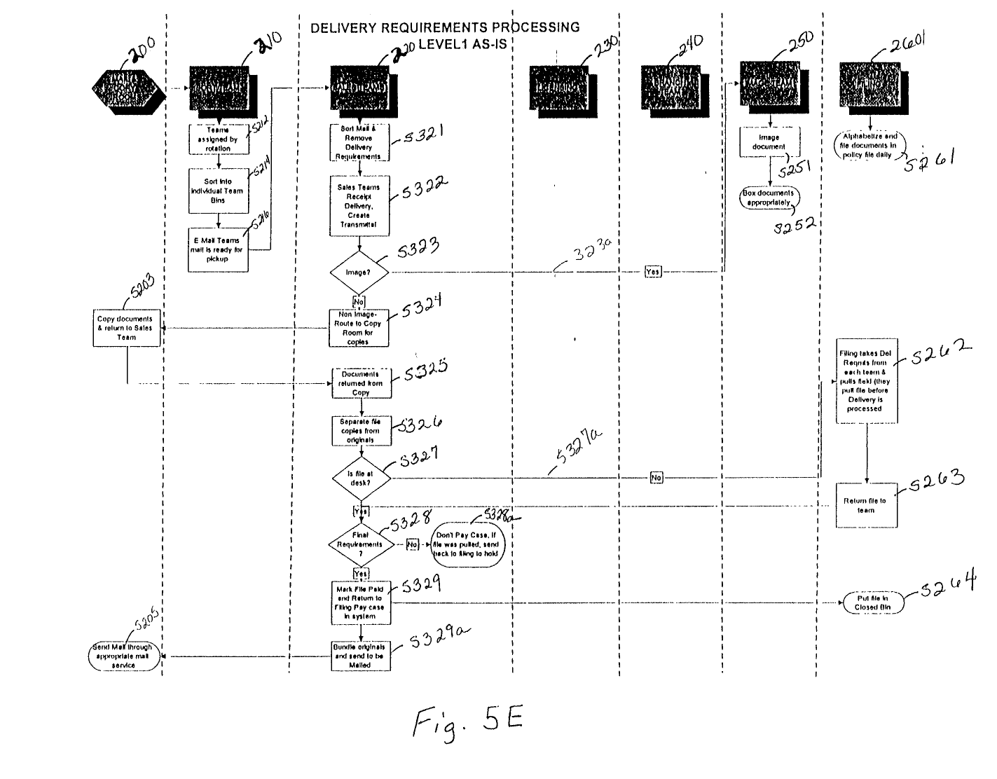

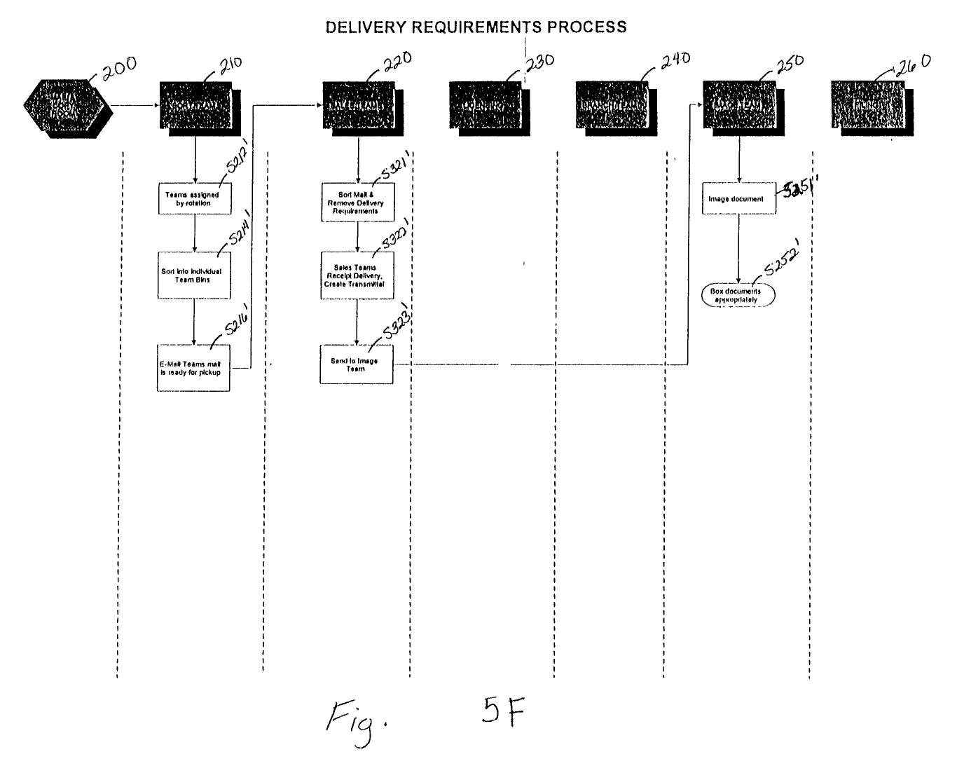

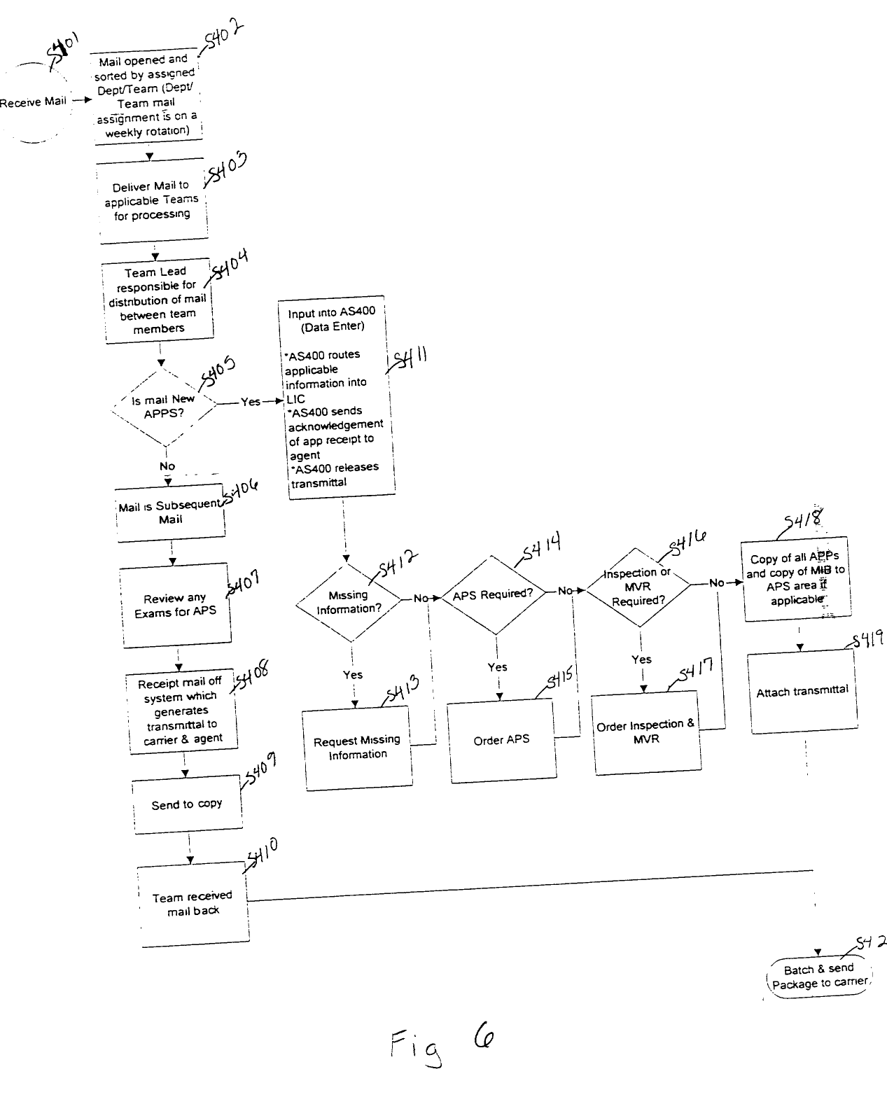

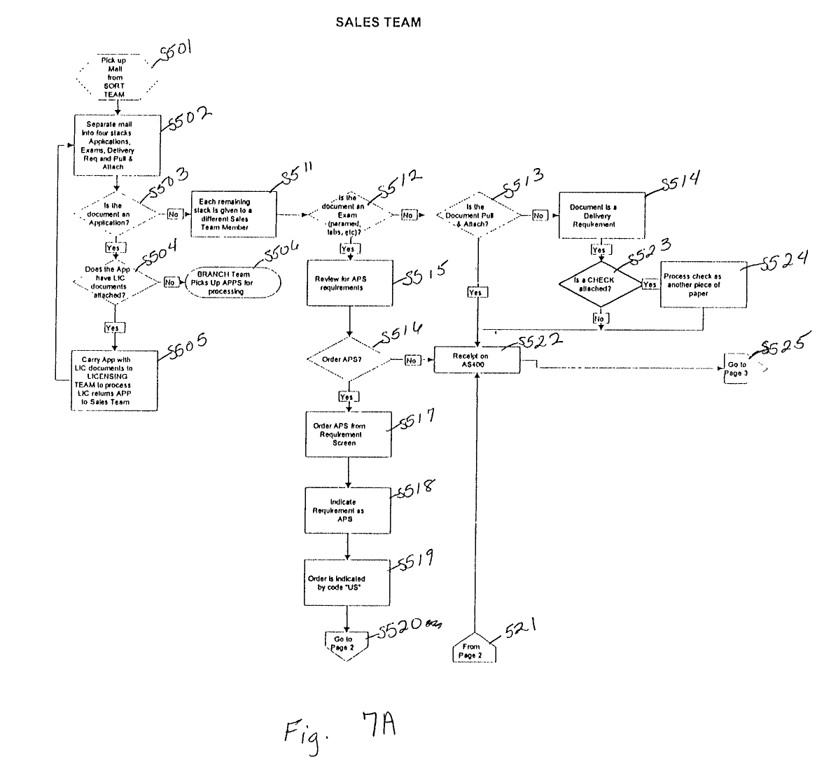

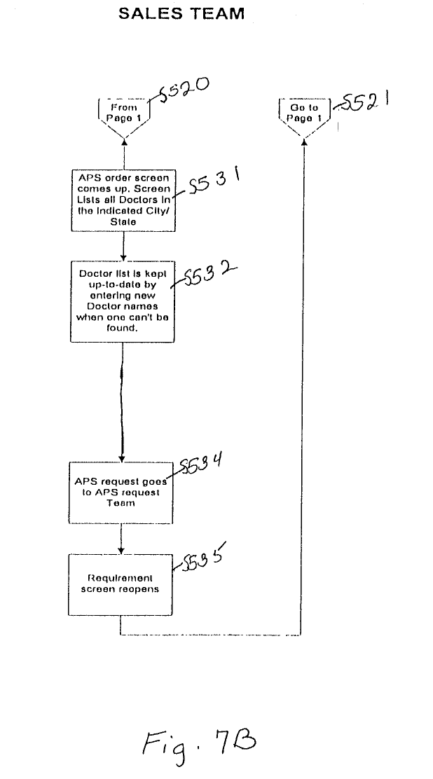

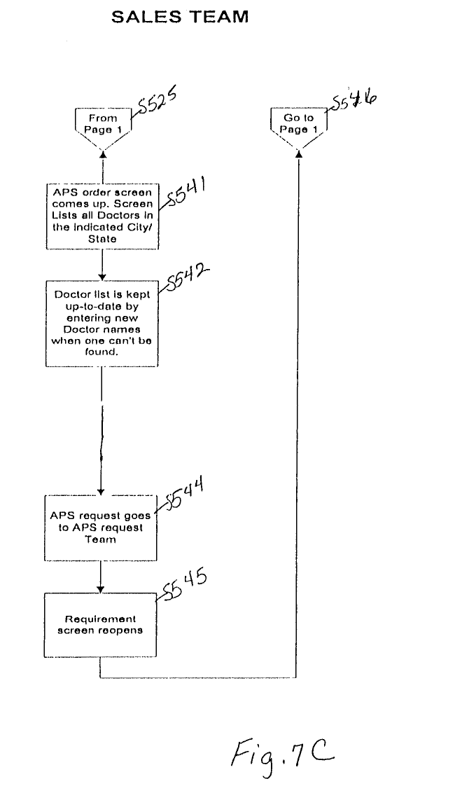

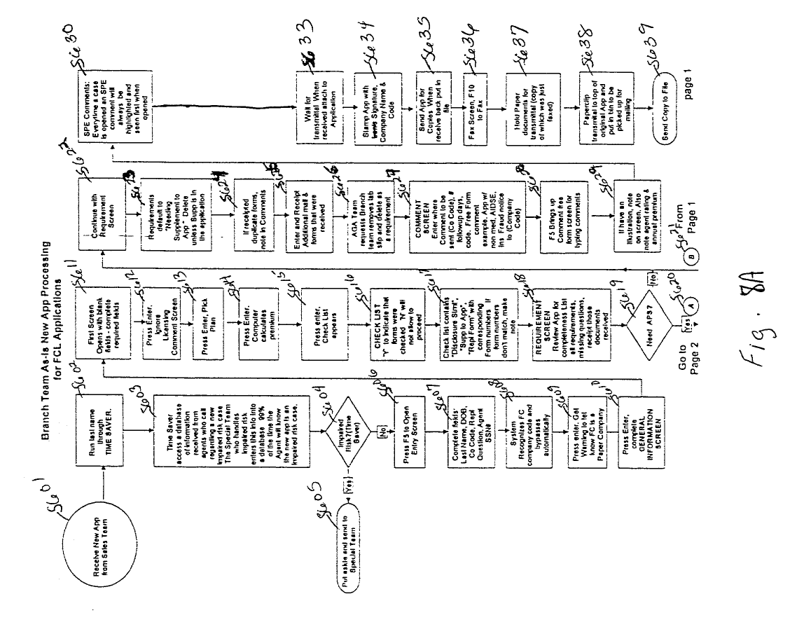

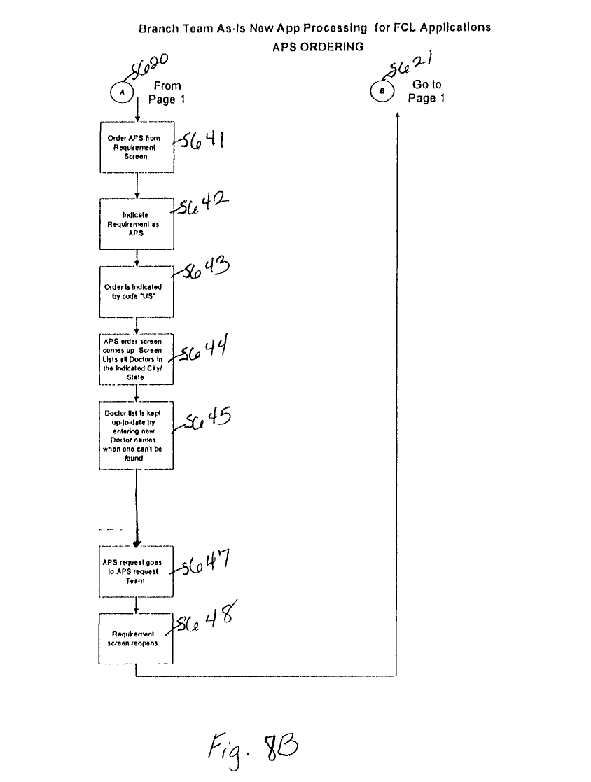

As shown in FIG. 4, the implementation component 120 comprises a plurality of process maps 122 and a plurality of document formats 124. The process maps 122 provide the entity with a plurality of detailed step-by-step instructions for executing a plurality of processes related to the Imaging System. Some of the process maps 122 provided to the entity may be process maps of the entity's current paper-based document handling and delivery system, so that the entity can compare its current document handling and delivery system to the new Imaging System. In addition, some of the process maps 122 may detail how the imaged documents will be handled when they arrive at their destination following transmission of the imaged documents to another entity, such as, for example, an insurance provider if the entity is an insurance broker or agent.

FIGS. 5A and 5B illustrate sample process maps for the processing of a new insurance application by an insurance broker (the entity in this example). The process map shown in FIG. 5A illustrates the steps conducted by the insurance broker when processing new insurance applications prior to implementing the Imaging System. In this example, the insurance broker's current document handling and delivery system supports some imaging, but some insurance applications are still delivered to the insurance provider via traditional mail delivery services.

As shown in FIG. 5A, the insurance broker's process for the handling and delivering of new insurance applications to the insurance provider, prior to implementing the Imaging System, involves the use of a mail and copy room 200, a sort team 210, a sales team 220 220, a licensing team 230, a branch team 240, and an image team 250.

A plurality of new insurance applications and other new mail are first received by the mail and copy room 200 and subsequently sent to the sort team 210. As step S212 indicates, the sort team 210 members are assigned by rotation. At step S214, the new mail is sorted into individual team member bins in accordance with work assignments. At step S216, the sort team 210 notifies the sales team 220 that the new mail is ready for pickup. In the present example, this notification is done via e-mail.

At step S222, the sales team 220 segregates the new applications from the other mail. At step S224, the sales team 220 determines if any licensing documents are attached to any of the new applications. If licensing documents are attached to any of the new applications, the applicable new application (together with the licensing documents) is routed directly to the licensing team 230 at step S226. Otherwise, if licensing documents are not attached to the new application, the new application is routed to the branch team 240 at step S227.

At step S232, the licensing team 230 processes the licensing documents included with the new application and returns the new application and the related licensing documents to the sales team 220, which then routes the new application and other related documents to the branch team 240 at step S227.

At step S242, the branch team 240 enters data related to the new application (e.g., name and social security number of an insured) into a database. At step S244, it is determined if the new application is one which can be imaged based on where the new application is being sent. If the application is one that can be imaged, the new application is sent to the image team 250. Otherwise, if the new application is not one that can be imaged, the new application is sent to the mail and copy room 200 for copying at step S246.

The process than proceeds to step S202, where a plurality of documents that make up the new application are copied and sent back to the branch team 240. The process then proceeds to step S248, where the branch team 240 bundles the copies received from the mail and copy room 200. At step S249, the original and copies of the new application documents are returned to the sales team 220 220.

The sales team 220 220, at step S228, separates the originals of the new applications from the copies of the new applications and files the copies of the new applications. At step S229, the sales team 220 sends the originals of the new applications to the mail and copy room 200 for sorting and mailing. At step S204, the mail and copy room 200 sends the original of the new applications to the insurance provider through an appropriate mail service.

If the new application is sent to the image team 250 at step S244, the image team 250 images the new application at step S252, and boxes the originals of the new application for storage at step S254.

For many entities, their current processes for handling and delivering documents have evolved and changed over time in response to their changing needs and objectives. Often, these processes are not well documented (e.g., the entities have not prepared process maps detailing their current processes). Documenting the entity's current document handling and delivery processes (for example, with process maps) can be an important tool, not only for determining the potential advantages of implementing the Imaging System, but also for gaining a better understanding of the entity's current document handling and delivery system. Accordingly, an aspect of the present invention is providing the entity with process maps that document the entity's existing document handling and delivery system.

FIG. 5B illustrates the process map for the steps used in processing new applications after the Imaging System has been implemented. A plurality of new insurance applications and other new mail is first received by the mail and copy room 200 and subsequently sent to the sort team 210. As step S212′ indicates, the sort team 210 members are assigned by rotation in a manner similar to that explained above. At step S214′, the new mail is sorted into individual team member bins in accordance with work assignments. At step S216′, the sort team 210 notifies the sales team 220 that the new mail is ready for pickup.

At step S222′, the sales team 220 segregates the new applications from other mail. At step S224′, the sales team 220 determines if any licensing documents are attached to any of the new applications. If licensing documents are attached to a new application, the new application and attached documents are routed directly to the licensing team 230 at step S226′. Otherwise, if a new application does not have any licensing documents attached thereto, the new application is routed to the branch team 240 at step S227′.

At step S232′, the licensing team 230 processes the licensing documents and returns the new application and the attached licensing documents to the sales team 220 220, which then routes the new application to the branch team 240 at step S227′.

At step S242′, the branch team 240 enters data related to the new application (e.g., name and social security number of an insured) into a database. At step S244′, the new application is sent to the image team 250. The image team 250 scans the new application and converts the paper-based new application into an electronic image of the new application at step S252′, and boxes the original paper-based new applications for storage at step S254′.

FIG. 5C is an example of a process map of the insurance broker's process for the handling and filing of “pull and attach” documents with the insurance provider prior to implementing the Imaging System. The “pull and attach” documents may include files or documents that are pulled and attached to requirements just received by the insurance broker. The process illustrated in FIG. 5C involves the use of a mail and copy room 200, a sort team 210, a sales team 220 220, a licensing team 230, a branch team 240, an image team 250 and a filing team 260.

A plurality of “pull & attach” documents are first received by the mail and copy room 200 and subsequently sent to the sort team 210. Steps S212, S214 and S216 are described above with regard to FIG. 5A.

At step S221, the sales team 220 segregates the pull & attach documents from the other mail. At step S223, the sales team 220 determines if any licensing documents are attached to any of the pull & attach documents. If any licensing documents are attached to any of the pull & attach documents, the applicable pull & attach documents, with the licensing documents attached, are routed directly to the licensing team 230 at step S223a. At step S231, the licensing team 230 processes the licensing documents included with the pull & attach documents.

If licensing documents are not attached to any of the pull & attach documents, the sales team 220 processes the pull & attach documents at step S225a. At step S225b, the sales team 220 determines if any of the pull & attach documents are documents that may be imaged. If any of the pull & attach documents may be imaged, the applicable pull & attach documents are routed to the image team 250 at step S225h. If any of the pull & attach documents may not be imaged, the non-image pull & attach documents are routed to the mail and copy room 200 for copies at step S225c.

The process than proceeds to step S203, where a plurality of documents that make up the pull & attach documents are copied and sent back to the sales team 220 at step S225d. The sales team 220 220, at step S225e, separates the originals of the pull & attach documents from the copies of the pull & attach documents. The copies are sent to the filing team 260 at step S225f. At step S261, the filing team 260 alphabetizes and files each pull & attach document daily in a policy file.

At step S225g, the sales team 220 sends the originals of the pull & attach documents to the mail and copy room 200 for sorting and mailing. At step S203, the mail and copy room 200 sends the originals of the pull & attach documents to the insurance provider through an appropriate mail service.

If any of the pull & attach documents are sent to the image team 250 at step S225h, the image team 250 images the applicable pull & attach documents at step S251. At step S253, the image team 250 boxes the originals of the pull & attach documents appropriately for storage.

FIG. 5D illustrates a sample process map for the steps used in processing pull & attach documents after the Imaging System has been implemented. A plurality of pull & attach documents and other new mail is first received by the mail and copy room 200 and subsequently sent to the sort team 210. As step S212′ indicates, the sort team 210 members are assigned by rotation in a manner similar to that explained above. At step S214′, the new mail is sorted into individual team member bins in accordance with work assignments. At step S216′, the sort team 210 notifies the sales team 220 that the new mail is ready for pick up. At step S221, the sales team 220 segregates the pull & attach documents from other mail. At step S223′, the sales team 220 determines if any licensing documents are attached to any of the pull & attach documents. If licensing documents are attached to a pull & attach document, the pull & attach document and attached documents are routed directly to the licensing team 230 at step S223A′.

If a pull & attach document does not have any licensing documents attached thereto, the pull & attach document is processed by the sales team 220 at step S225A′. The sales team 220 then forwards the pull & attach documents to the image team 250 at step S225B′. At step S231′, the licensing team 230 processes the licensing documents.

At step S251′, the image team 250 scans the pull & attach documents and converts the paper-based pull & attach documents into electronic images of the pull & attach documents at step S251′. The image team 250 boxes the original paper-based pull & attach documents for storage at step S253′.

FIG. 5E illustrates a sample process map for the insurance broker's process for delivery requirements processing prior to implementing the Imaging System. After the delivery requirements documents and other new mail are received by the mail and copy room 200, they are sent to sort team 210. The sort team 210 processes the delivery documents along with the new mail in steps S212, S214 and S216 as described above with reference to FIGS. 5A and 5C. At step S321, the sales team 220 sorts the mail and removes the delivery requirements documents from the other mail. At step S322, the sales team 220 receives the delivery requirements documents and creates a transmittal for the delivery requirements documents. At step S323, the sales team 220 determines if the delivery requirements documents are documents that may be imaged.

If a delivery requirements document is one that may be imaged, the applicable delivery requirements document may be forwarded to image team 250 at step S323A. Otherwise, if a particular delivery requirements document is one that may not be imaged, the non-image delivery requirements document may be routed to the mail and copy room 200 at step S324. The mail and copy room 200 may copy the delivery requirements documents and return the delivery requirements documents to the sales team 220 220. At step S203, as described above with reference to FIG. 5C.

At step S325, the delivery requirements documents are received by the sales team 220 from the mail and copy room 200. At step S326, the sales team 220 segregates the originals of the delivery requirements documents from the copies of the delivery requirements documents and files the copies of the delivery requirement documents.

At step S327, the sales team 220 determines if the file for the delivery requirement document is physically located with the sales team 220 220. If the delivery requirements document file is not physically located with the sales team 220 220, the delivery requirements document is forwarded to the filing team 260 at step S327A. The filing team 260 takes the delivery requirements documents received from each team and pulls the file(s) associated with the particular delivery requirements documents at step S262. At step S263, the filing team 260 returns the file to the sales team 220 220.

If the file(s) for the delivery requirements documents are located with the sales team 220 220, the sales team 220 determines if the final requirements for the file have been met at step S328. If the final requirements have not been met, the sales team 220 does not pull the case and send the file, if pulled, back to the filing team 260 at step S328A. If the final requirements have been met, at step S329, the sales team 220 may mark the file paid and return the file to the filing team 260 to enter the case into the insurance provider's system.

At step S264, the filing team 260 may put the file in a “closed” bin. At step S329A, the sales team 220 may bundle the originals of the delivery requirement documents and send the originals to the mail and copy room 200 to be mailed. At step S205, the mail and copy room 200 may send the originals of the delivery requirement documents to the insurance provider through an appropriate mail service.

FIG. 5F illustrates a process map for the steps performed in a delivery requirements documents processing process after the Imaging System has been implemented. A plurality of new mail including delivery requirements documents is received by the mail and copy room 200 and subsequently sent to the sort team 210. The sort team 210 processes the received mail in steps S212′, S214′ and S216′ as described above with reference to FIG. 5D.

At step S321′, the sales team 220 segregates the delivery requirements documents from other mail. At step S322′, the sales team 220 receives delivery of the delivery requirements documents and creates a transmittal. At step S323′, the sales team 220 transmits the delivery requirements documents to the image team 250.

At step S251′, the image team 250 scans the delivery requirements documents and converts the paper-based delivery requirements documents into electronic images of the delivery requirements documents at step S251′. The image team 250 boxes the original paper-based delivery requirements documents for storage at step S252′.

FIG. 6 illustrates one embodiment of a process for receiving and forwarding mail in the mail and copy room 200. At step S401, the mail and copy room 200 receives mail. At step S402, the mail may be opened and sorted by an assigned department or team. The department or team may be assigned on a weekly rotation basis. At step S403, the mail may be delivered to the applicable teams for processing.

At step S404, the team lead responsible for distribution of mail between team members receives the mail. At step S405, the team lead determines if the mail is a new application. If the determination in step S405 is affirmative, then the mail is designated as subsequent mail at step S406. At step S407, the mail is reviewed for inclusion of any Attending Physician Statements (“APS”). Attending Physical Statements may include copies of medical records sent to the insurance company. The APS's may be mailed by a doctor or other medical entity.

At step S408, a transmittal is generated to the carrier and/or agent. At step S409, the mail is sent to be copied. At step S410, the team lead receives the mail back. At step S420, the team lead batches and sends the package to the insurance carrier.

If particular incoming mail is determined to include new applications at step S405, then data regarding the new applications may be entered into a computer system at step S411. The computer system may include any type of computer system that may be used to store documents. In one embodiment, the computer system may include a mainframe type computer system. The computer system may route the applicable data to the licensing department, and send an acknowledgement that the new application was received to the submitting agent.

At step S412, a determination is made as to whether any information is missing from a submitted new application. If information is missing, the missing information is requested at step S413. If the information is not missing, at step S414, it is determined whether an APS is required. If an APS is required, the APS is ordered at step S415. If an APS is not required, at step S416 it is determined whether a motor vehicle inspection or a motor vehicle report (“MVR”) is required.

If a motor vehicle inspection or a MVR is required, the motor vehicle inspection and/or MVR may be ordered at step S417. If a motor vehicle inspection or MVR are not required, or after any required motor vehicle inspections and/or MVRs have been ordered, all of the applications and Medical Information Bureau (“MIB”) information may be copied. The MIB is a company that collects information from insurance companies regarding their customers. The MIB may be used by insurance companies to obtain information regarding customers, such as, for example, whether a customer has applied elsewhere and any conditions of the customer the insurance company may need to seek.

At step 419, a transmittal may be attached to the received new applications. At step S420, the received new applications may be batched and sent in a package to the insurance carrier.

FIGS. 7A-7C are sample process maps for the processing of mail by the sales team 220 220. FIG. 7A illustrates a first section or a first page of a process map for the processing of mail by the sales team 220 220. At step S501, the sales team 220 picks up the received mail from the sort team 210. At step S502, the mail is separated into at least four stacks, including applications, exams, delivery requirements documents and pull & attach documents.

At step S503, the sales team 220 determines if a particular document is an application. If the document is an application, at step S504, the sales team 220 determines if the application has licensing documents attached. If the application does have licensing documents attached, the sales team 220 routes the application with the licensing documents to the licensing team 220 to process. The licensing team 230 returns the application to the sales team 220 and the process returns to step S502. If the application does not have licensing documents attached, at step S506, the branch team 240 fixes up the applications for processing.

If a document received is not an application, at step S511, such document is given to a different sales team 220 member. At step S512, the sales team 220 member determines if the document is an exam. Exams may include paramedic exams, lab exams, etc. If the document is an exam, the document may be reviewed for APS requirements at step S515. At step S516, the sales team 220 may determine whether an APS needs to be ordered. If an APS needs to be ordered, at step S517, the sales team 220 may order the APS using a requirements screen. At step S518, the sales team 220 member may indicate the requirement as an APS. At step S519, the order may be indicated by a code, such as, for example, the code “US” to indicate that the sales team 220 ordered the requirements. At step S520, the process proceeds to the second page of the process.

If the document is not an exam document, at step S513, the sales team 220 determines if the document is a pull & attach document. If the document is a pull & attach document, the document is receded on the system at step S522. The process may then proceed to step S525 and the third page of the process map.

If the document is not a pull & attach document, at step S514, the document is determined to be a delivery requirements document. At step S523, the delivery requirements document is examined to see if a check is attached. If a check is attached to the delivery requirements document, the check is processed as another document at step S524. If a check is not attached or after the check has been processed, the document is receded on the system at step S522. At step S521, the processing completed at the second page is returned and receded on the system at step S522.

FIG. 7B represents the second page of processing on the sales team 220 process map. At step S520, the application is received from page 1. At step S531, an APS order screen is generated. The APS order screen may list all of the doctors located in an indicated city or state. At step S532, the doctor list is kept up to date by entering new doctor names when one cannot be found. At step S534, the APS request may be sent to an APS request team. At step S535, the requirement screen reopens. At step S521, the process returns to page 1.

FIG. 7C illustrates the third page of the processing map for the sales team 220. At step S525, the documents are received from the process on page 1 of the process map. At step S541, an APS order screen is generated listing all the doctors located in an indicated city or state. At step S542, the doctor list is kept up to date by entering new doctor names when one cannot be found. At step S544, an APS request goes to the APS request team. At step S545, the requirements screen reopens indicating that the APS has been received and matched to the corresponding file. At step S546, the process returns to page 1 of the process map.

FIGS. 8A-8C illustrate the process map in the branch team 240 before the Imaging System has been implemented. At step S601, a new application is received by the branch team 240 from the sales team 220 220. At step S602, the branch team 240 runs a last name of an insured party found on a received new application through a time saver program. At step S603, the time saver program accesses a database of information. The accessed database of information may be received from agents who call regarding a new impaired risk case. A special team handling the impaired risk case may enter required information into the database of information. At step S604, the branch team 240 determines if the new application relates to an impaired risk case. If the new application relates to an impaired risk case, at step S605, the new application related to the impaired risk case may be set aside and sent to the special team at step S605.

If the new application is not related to an impaired risk case, an information entry screen may be opened at step S606 for entering information relating to the new application. At step S607, a plurality of predetermined fields in such entry screen may be deleted. For example, some of the fields may request entry of a last name, a date of birth, a company code, replies to any questions, an agent and/or a social security number. At step S608, the system may recognize the company code and automatically bypass the field for entry of this code. At step S609, the branch team 240 may receive a warning indicating that the company code relates to a paper company. At step S610, the branch team 240 may complete a general information screen. At step S611, a first screen may open with a plurality of blank fields for entry of requested information and the branch team 240 may complete the required fields.

At step S612, the branch team 240 may be presented with a licensing comment screen. In one embodiment, the licensing comment screen may be ignored by the branch team 240 user. At step S613, the branch team 240 may select an insurance plan for the insured party submitting the new application. At step S614, the computer may calculate a premium based on the insurance plan selected and the information entered. At step S615, a checklist may appear. At step s616, the checklist may be completed with a “Y” or “N” by a user. In one embodiment, the checklist may be completed by a sales specialist. A “Y” may indicate that the forms were checked. Input of a “N” will not allow the process to proceed.

At step S617, the branch team 240 may compare the items of the checklist with a plurality of corresponding phone numbers. If the corresponding phone numbers do not match, the branch team 240 may make a note. At step S6128, a requirements screen may be generated. The branch team 240 may review the application for completeness, list all requirements, and receive documents on the requirements screen. For example, at step S619, the branch team 240 may determine whether an APS is needed. If an APS is needed, the process may proceed to page 2 of the process at step S620. If an APS is not needed, or if page 2 of the process map has previously been completed, the process proceeds to step S622 where the requirements screen is continued. At step S623, the requirements screen may default to one requiring a supplement to an application. The branch team 240 may delete the default unless the required supplement is submitted with the application. At step S624, if there are duplicate forms, the branch team 240 may make a note in the comments. At step S625, the branch team 240 may enter and receive additional mail and forms that were submitted. At step S625, an AGA team may request the branch team 240 to remove a lab slip and delete the lab slip as a new requirement. At step S627, a comment screen may be generated. The branch team 240 may enter information into the comments field, such as, a company code, for example. The branch team 240 may also enter free form comments such as “application with non-medical,” “AIDSE,” and “insurance fraud notice to (company code).”

At step S628, the comment free form screen may be accessed in order to input such comments. At step S629, if an illustration is included, a note is made on the screen. An agent rating and annual premium may also be noted on the screen. At step S630, specialist (“SPE”) comments may be entered. In one embodiment, each time a case is opened, a SPE comment may always be highlighted and seen first when opened.

At step S633, the branch team 240 may wait for a transmittal. When the transmittal is received, the branch team 240 may attach the transmittal to the application. At step S634, the branch team 240 may stamp the application with a signature, a company name and a code. At step S635, the branch team 240 may send the application for copies. When the copies are received, they may be put in the file. At step S636, the data entry screen may be printed or faxed.

At step S637, paper document(s) for transmittal may be held until a transmittal is printed, so that the document(s) and the transmittal may be attached together. At step S638, the transmittal may be paper-clipped to the top of the original application and put in a bin to be picked up for mailing. At step S639, the copy may be sent to filing.

FIG. 8B illustrates the second page of the process map for processing new applications by the branch team 240. At step S620, a new application is received from page 1 of the process. At step S641, an APS may be ordered from the requirements screen. At step S642, the requirements screen may indicate that an APS is required. At step S643, the order may be indicated by code, such as, the code “US.”

At step S644, the APS order screen may be generated. The APS order screen may list all doctors located in an indicated city or state. At step S645, the doctor list may be kept up to date by entering new doctor names when prior doctor names cannot be found. At step S647, the APS request goes to the APS request team. At step S648, the requirements screen reopens. At step S621, the process is returned to page 1 of the branch team 240 process map for new applications.

FIGS. 8C-8E represent the process map for new application processing by the branch team 240 after the Image System has been implemented. A new application may be picked up from the sales team 220 at step S601′ as described above with reference to FIG. 8A. At step S651, the information entry screen may be opened by the branch team 240. At step S652, a member of the branch team 240 may complete the fields in the information entry screen as described above with reference to step S607 of FIG. 8A. At step S653, an agent screen may be opened. At step S654, the branch team 240 may determine whether an agent has been appointed. If an agent has not been appointed, the branch team 240 may proceed to page 3 of the process map as described with reference to FIG. 8E.

If an agent has been appointed, or if the process of page 3 has been completed and returned at step S671, the last names of the insured parties may be automatically run through a time saver program as described with reference to step S602 of FIG. 8A. The branch team 240 may then perform steps S603′-S605′ as described above with reference to steps S603-S605 of FIG. 8A to determine whether the new application is an impaired risk case.

The branch team 240 may then perform steps S610′-S631′ in a manner similar to steps S610-S631 of FIG. 8A. At step S633′, the branch team 240 may wait for a transmittal which will be attached to the application when received. At step S634, the branch team 240 may stamp the application with a signature, a company name and a company code.

At step S657, the branch team 240 may determine whether the new application is a companion to a prior case. If the application is a companion to a prior case, the branch team 240 may stamp the application as “transmittal one of ______” and write the names of the companion cases on the transmittal. If the application is not a companion to a prior case or if the application has been stamped as a companion to a prior case, at step S659, the transmittal may be paper-clipped to the top of the application and sent to the image team 250.

FIG. 8D illustrates the second page of the process map for new application processing by the branch team 240 after the Image System has been implemented. At step S620′, the second page of the process map receives the new application from the first page. At step S661, the branch team 240 determines if errors have been found in a quality control “QC”) department. At step S662, if errors have been found in QC, they may be added to a special requirements/request field on the comment screen. At step S663, a case review memo may be generated and faxed to an agent.

If errors are not found in QC, at step S664, the branch team 240 may check to see if a check is attached to the new application. If a check is attached to the new application, at step S665, the branch team 240 may check to see if the check is made payable to the appropriate entity. At step S666, if the check is not made payable to the appropriate entity, the branch team 240 may determine if the check is endorsed. If the check is not endorsed, the check may be returned to the agent at step S667. If a check is not attached to the new application or the check is made payable to the appropriate entity and the check is endorsed, the process may proceed to step S668. At step S668, the branch team 240 may determine if an APS is needed. If an APS is needed, the branch team 240 may complete steps S641′-S645′ in a manner similar to steps S641-S645, described above, with reference to FIG. 8B. At step S647′, the APS request goes to the APS request team. If an APS is not needed or the APS request has been sent to the APS request team, at step S648′, the requirements screen reopens. At step S621′, the process returns to page 1 of the process map.

FIG. 8E illustrates page 3 of the process map for the new application processing by the branch team 240 after the Image System has been implemented. At step S670, the new applications are received from page 1 of the processing map. At step S672, the branch team 240 determines if a particular new application is in a restricted state. If a particular new application is in a restricted state, at step S677, the new application may be returned to the sales team 220 which will then return the new application to the agent. If the new application is not in a restricted state, at step S673, the branch team 240 may determine if the new application is in a sensitive state. If the new application is in a sensitive state, at step S674, the application may be entered and the comments sent to the sales team 220 indicating that an agent license is needed as soon as possible.

If the new application is not in a sensitive state or if a comment has been sent to the sales team 220, at step S676, an insurance plan may be chosen. At step S671, the process returns to page 1 of the process map.

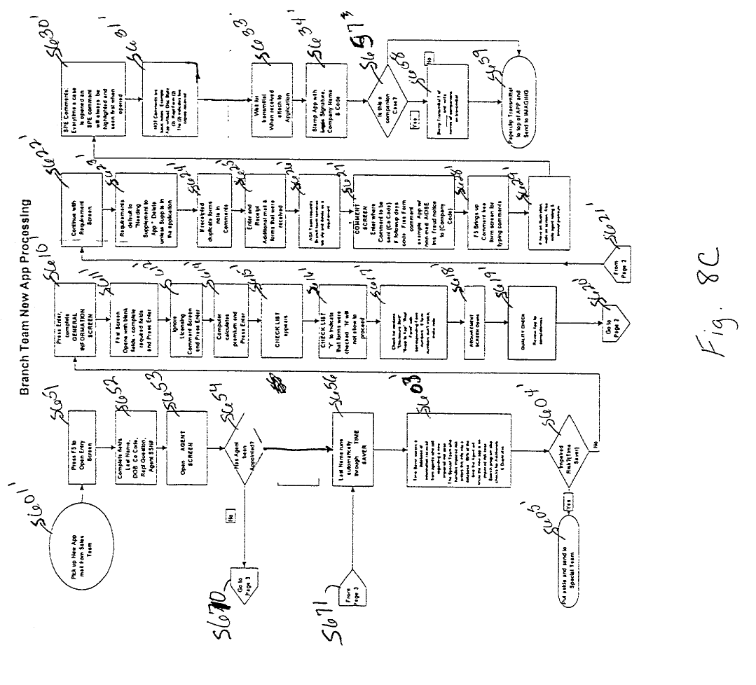

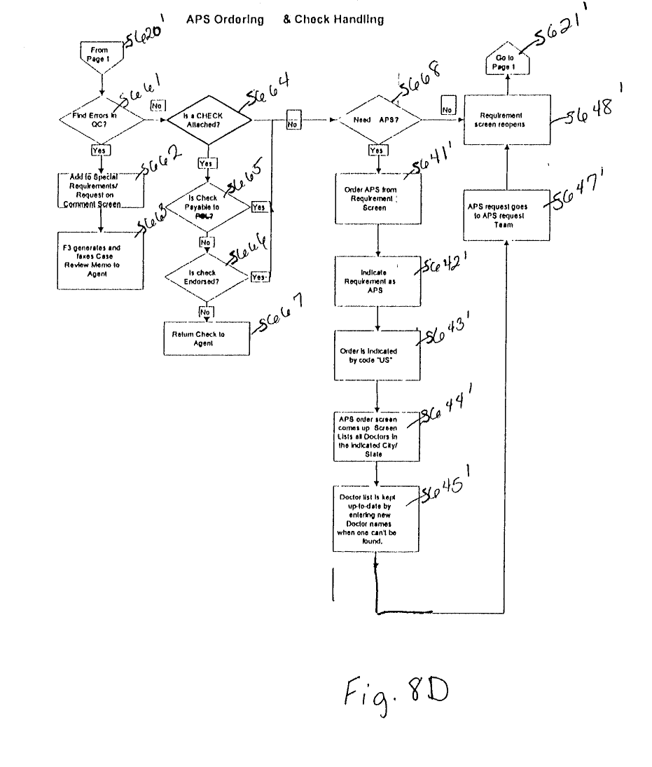

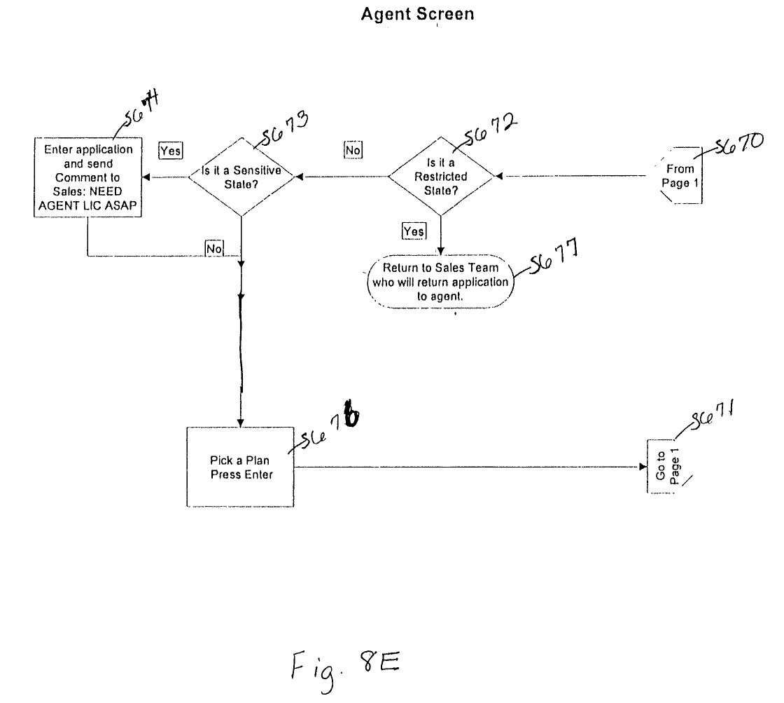

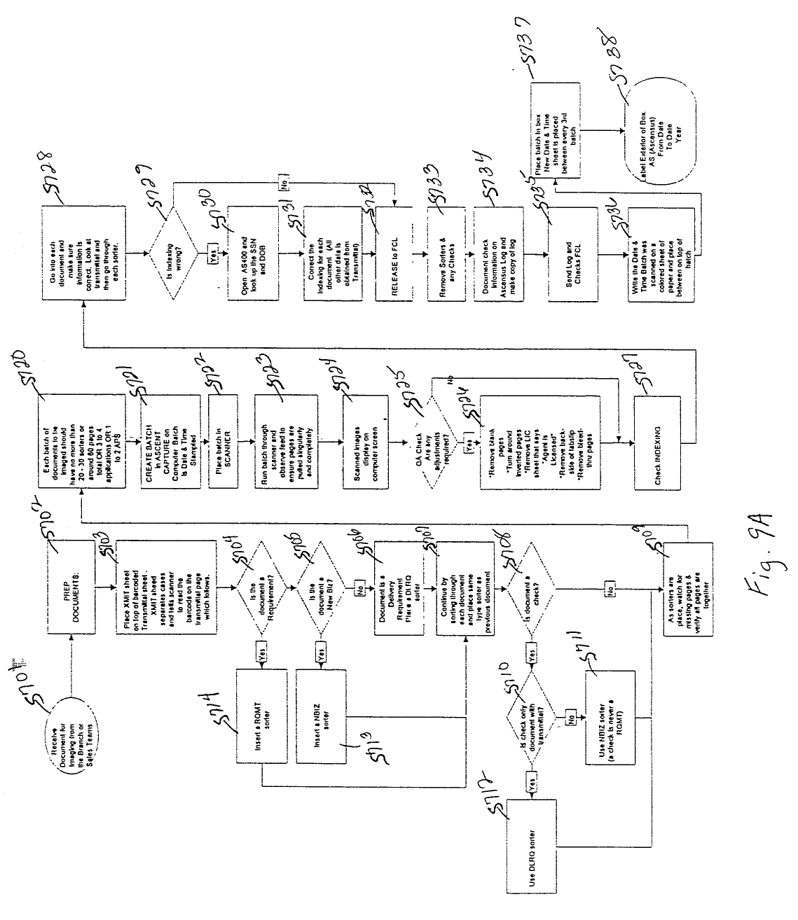

FIGS. 9A-9E illustrate processes performed by the imaging team 250 after the Imaging System has been implemented. At step S701, a document may be received from the branch team 240 or sales team 220. At step S702, the received documents may be prepared for imaging. At step S703, a transmittal sheet may be placed on top of a bar-coded transmittal sheet. The transmittal sheet may separate the received document and alert scanners to read a bar code on a transmittal sheet which follows.

At step S704, the imaging team 250 determines if the received document is a requirements document. If the received document is a requirements document, at step S714, a requirements sorter may be inserted. If the received document is not a requirements document, the imaging team 250 may determine if the received document is a new business document at step S705. If the received document is a new business document, at step S713, the imaging team 250 may insert a new business sorter at step S713.

If the received document is not a new business document, at step S706, the imaging team 250 may determine that the received document is a delivery requirements document and insert a delivery requirements sorter. At step S707, after the appropriate sorter has been inserted, the imaging team 250 may continue by sorting through by each received document and placing the same type of sorter as into the process as the sorter used in connection with the previous document.

At step S708, the imaging team 250 may determine if the received document is a check. If the received document is a check, at step S710, the imaging team 250 may determine if the check is the only received document included with a transmittal. If the check is the only received document included with a transmittal, a delivery requirements sorter may be used at step S712. If the check is not the only document received with a transmittal, at step S711, a new business sorter may be used. At step S709, if the received document is not a check, or after the appropriate sorter has been chosen, the imaging team 250 may watch for missing pages and verify that all pages are together.

At step S720, each batch of received documents to be imaged is checked. In one embodiment, the batch of received documents should have no more than 20-30 sorters and should be no greater than 60 pages total. In one embodiment, the batch of received documents should not include more than 3 or 4 new applications or more than 1 or 2 APS.

At step S721, a batch is created in a capture on a computer. The created batch may be date and time-stamped. At step S722, the created batch may be placed in a scanner. At step S723, the created batch may be fed through the scanner and the feed observed to ensure that all pages of the created batch are fed through the scanner singularly and completely. At step S724, a plurality of images from the scanner are displayed on the computer screen. At step S725, a quality assurance department may determine if any adjustments are required. At step S726, if adjustments are required, the required adjustments may be made. Adjustments required may include removing blank pages, turning around inverted pages, removing licensing sheets, removing backsides of labslips and removing bleed-through pages.

At step S727, if adjustments are not required or if the adjustments have been made, check indexing is performed. At step S728, the imaging team 250 may review each document and make sure the information included in each document is correct. This review may include looking at the transmittal and going through each sorter. At step S729, the imaging team 250 may determine if indexing is wrong. If indexing is wrong, at step S730, the imaging team 250 may look up social security number and date of birth in the insurance system.

At step S731, the Imaging System may correct the indexing for each document. At step S732, if indexing is correct or if the imaging has been corrected, the Imaging System may release the document to the appropriate company. At step S733, the Imaging System may remove sorters and any checks.

At step S734, document check information may be entered on a log and a copy made of the log. At step S735, the log and checks may be sent to the appropriate insurance carrier. At step S736, a date and a time the batch is scanned may be written on a paper and placed on top of the scanned batch. At step S737, the scanned batch may be placed in a box. In one embodiment, a new date and time sheet may be placed between every third scanned batch. At step S738, the exterior of the box may be labeled. For example, a label name may include a day and a year.

FIG. 9B is a process map illustrating a workflow of an imaging process. The workflow of the imaging process may include a service unit 740, a first data entry unit 750 and a second data entry 760.

As shown in FIG. 9B, the workflow begins at Step 741 wherein the service unit 740 may receive an image download from an agent. The image download may include a new application. At step S742, the service unit 740 may process an index queue for the image download. At step S743, the service unit 740 may check the number of pages included in the image download and may conduct QC. At step 744, the service unit 740 may determine if the new application is one of a predetermined set of applications. If the new application is one of the predetermined set of applications, at step S745, the new application may be sent to the second data entry unit 760. If the new application is not one of the predetermined set of applications, at step S746, the new application may be sent to the first data entry unit 750. In one embodiment, the first data entry unit 750 may include a data entry unit.

At step S751, the data entry unit may receive work from the process queue. At step S752, the data entry unit may determine if the new application is one of the predetermined set of applications at step S752. If the new application is one of the predetermined set of applications, at step S753, the India data entry unit may send the new application to the second data entry unit at step S753. If the new application is not one of the predetermined set of applications, at step S754, the data entry unit may submit the new application to a policy data entry system. At step S755, the data entry unit may load any applicable requirements relating to the new application. At step S756, the data entry unit may automatically send a new application message to the case manager/underwriter (“CM”/“UND”).

At the second data entry unit 760, the second data entry unit 760 may receive work from the process queue at step S761. At step S762, the second data entry unit 760 may determine if the new application is one of the predetermined set of applications. If the new application is one of the predetermined set of applications, the second data entry unit 760 may submit the new application into a native mainframe insurance system. In one embodiment, the second data entry unit 760 may represent a geographically closer data entry unit that is separate from a customer site.

At step 764, the second data entry unit 760 may load the applicable requirements if the document received is a new application. If the document received has a predetermined designation of “add”, “alt” or “reopen”, the requirements may be deleted at step S764. For example, if the document received is a document that is associated with a case that has an additional insurer (“add” document) or an alternate insurer (“alt” document) added to it after work has started on the case, the requirements may be deleted at step S764. The requirements may then be reordered. Also, if a document received is associated with a case that has been reopened (“reopen” document), the requirements may be deleted at step S764 and reordered.

If the new application is not one of the predetermined set of applications, the second data entry unit 760 may submit the application to a policy data entry system at step S765. At step S766, the second data entry unit 760 may load the applicable requirements if a document received is a new application and may delete requirements if the document received is an add, alt, or reopen document. At step S767, the second data entry unit 760 may automatically send the new application message to the CM/UND or send an e-mail for a received document that is an add, alt, or reopen document.

FIG. 9C is a process map for a New Business “drop and drag” process. A New Business group may be a department of the insurance company. The “drag and drop” process may be implemented via use of a software program to build a new insurance policy. At step S801, images may be generated after processing imaging files using an Imaging System. At step S802, a process icon may be clicked. At step S803, the Imaging System may check any pending records. At step S804, the Imaging System may determine if a pending record is found. If a pending record is found, at step S805, the Imaging System may determine if the pending record may be used. If the existing, pending record may be used, at step S806, if more than one pending record exists, the appropriate pending record may be highlighted and the highlighted record may be clicked on.

If the existing, pending record may not be used, then at step S820, the user may click on the “ASSIGN NEW” button. At step S821, the user may click on the “FORCE NEW NUMBER” button. If the pending record is not found at step S804, or if steps S806 or S821 have been completed, the user may click on the OK button to indicate the record to be used. Imaging System lookup. At step S809, the user may expand each work object. In one embodiment, the user may double-click on a work object. At step S810, the user may verify that the work object and source relate to the policy number and are correctly scanned and labeled. At step S811, the user may determine if the image and work object information are correct.

If the image and work object information are not correct, at step S812, the user may make the appropriate corrections or label the image as a “bad scan”. At step S813, if the image and work object information are correct, or if any needed corrections have been made, or a bad scan labeled, the user may drag and drop the work object from a lookup result screen into an NB case in a process screen. At step S817, the user may choose to update the NB case screen by clicking on “update”. At step S818, the user may click on a “get work” button in the process screen. At step S819, the user may determine if another NB case appears. If another NB case appears, the process returns to step S807. If another NB case does not appear, the user may click on “exit” at step S822 to complete the process.

FIGS. 9D and 9E illustrate an image error resolution process map. At step S901, a user may open an error queue and find an error. At step S902, a work object may be expanded. At step S903, the user may review a history of the work object to see a reason for a bad scan if reasons are available. At step S904, the user may determine if the reason for the error is due to a mismatched mail situation, for example.

If the reason for the error is due to a mismatched mail situation, at step S912, the user may highlight the work object. At step S913, the user may right-click on the work object and find a parent of the work object. At step S914, the user may determine if a policy folder and/or a case comes up. If the policy folder and/or the case do come up, the user may expand on both at step S915. At step S916, the user may break a relationship between the work object and the policy folder for an incorrect work object. At step S917, the user may delete all information from the policy folder if the policy holder is empty. The user may right-click on the policy folder and view the detail. Or, the user may delete the policy folder by making the fields in the policy folder blank. This uncreates an incorrect policy folder that referenced the non-imaged file. At step S918, the user may put the correct information in each work object, source and case. The process may then return to step S912.

If the policy folder and/or case does not come up at step S914, at step S919, the user may determine if an UND folder and/or a case list comes up. If the UND folder and/or case list does come up in step S919, the user may expand on both at step S920. At step S921, the user may break a relationship between the work object and the UND policy folder of an incorrect work object. At step S922, the user may put the correct information in each work object, source and case itself and return to step S912.

If the UND folder and/or case list does not come up at step S919, at step S923, the user may access the parent the case queue to be indexed and the status to be scanned. This will allow the entire case to be reindexed. At step S924, the user may allow the case to reindex itself by double-clicking on case or close parent screen and clicking on refresh on the original lookup screen. At step S925, the incorrect correspondence may disappear from the error queue.

If the reason for error is not due to a mismatched mail situation at step S904, at step S905, the user may determine if the reason for the error is due to a mismatched work object. If the reason for the error is due to a mismatched work object, the user may proceed to an image exception processing service unit at step S950. If the reason for the error is not due to a mismatched work object, at step S906, the user may determine if the reason for the error is due to a poor image quality/illegible image. If the reason for the error is poor image quality/illegible image, at step S950, the user may proceed to the image exception processing service unit.

If the reason for the error is not due to poor image quality or an illegible image, at step S907, the user may determine that the error is due to a more than one PI material in one mail case. At step S908, the user may expand on a mail case at issue. At step S909, the user may determine by research which work objects are correct for the mail case and which are not. At step S910, the user may choose one of the incorrect work objects and highlight it. The user may then find the parent and see the mail cases and folder of the work object selected. At step S911, the user may expand on the folder icon for the work object selected and proceed to step S930 described with reference to FIG. 9E.

FIG. 9E represents the second part of the image error resolution process map. At step S930, the process is continued from FIG. 9D. At step S931, the user may break out the incorrect work object. At step S932, the user may expand the mail case in the parent screen and break out the incorrect work object for the mail case in the find parent screen. At step S933, the user may close the find parent screen. The user may close the find parent screen for both the UND folder and the policy (“POL”) folder. At step S934, the user may click on “create work” button in the Imaging System. At step S935, the user may choose a mail case and set a status to “scan” when the screen opens to create work. At step S936, when the “create work” screen is opened up, the user may put incorrect information for all data broken out by viewing sources and viewing “alpha”. At step S937, the user may click on a “create” button. At step S938, a new screen may appear with the mail case and the correct information. At step S939, the user may go into the original mail case that is still open and correct each work object and source. At step S940, the user may bring back the “create work” screen and place it next to the original mail case without letting them touch. At step S941, the corrected work object and sources are free because the links were broken. The user may send, drag, and drop the work object and sources into the newly created mail case at step S941. At step S942, the new mail case should have a status of “scanned”. The user may close or index the newly created mail case. At step S943, the correct work object in the original policy folder are left. At step S944, the user may refresh the original mail case screen. At step S945, the user may expand the original mail case again to verify that all incorrect work objects are deleted. At step S946, the user may change the queue to “index” and change the status to “scan”. In one embodiment, the user should change the queue to “index” first and then change the status to “scan”. At step S947, the user may refresh or allow the mail case to index itself. At step S948, the user may close or reindex the mail case.

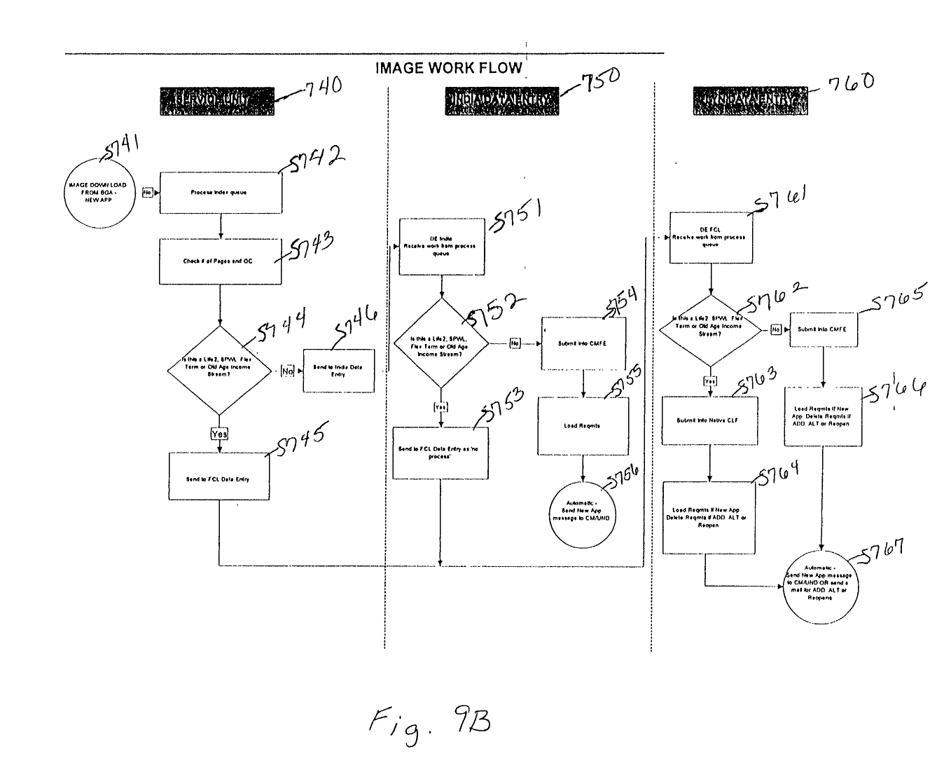

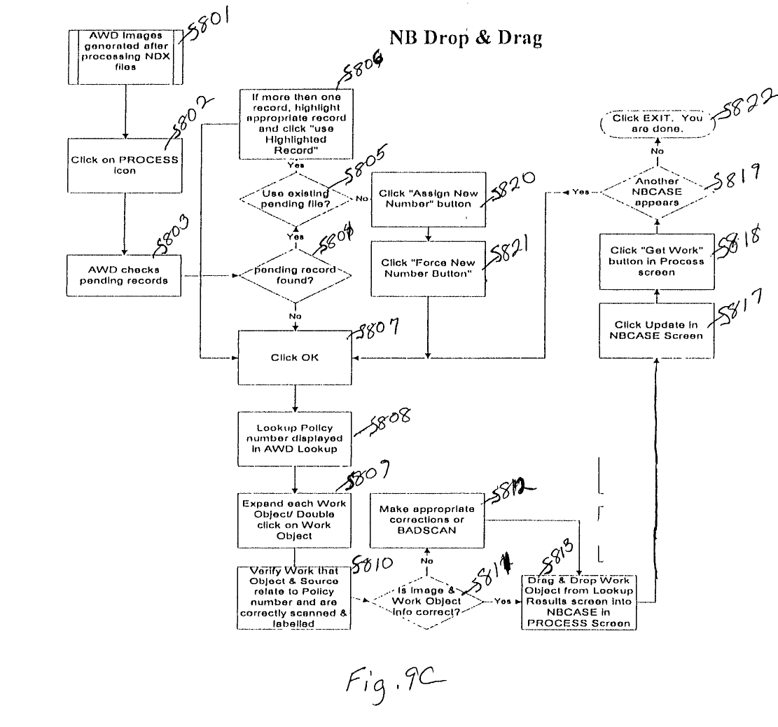

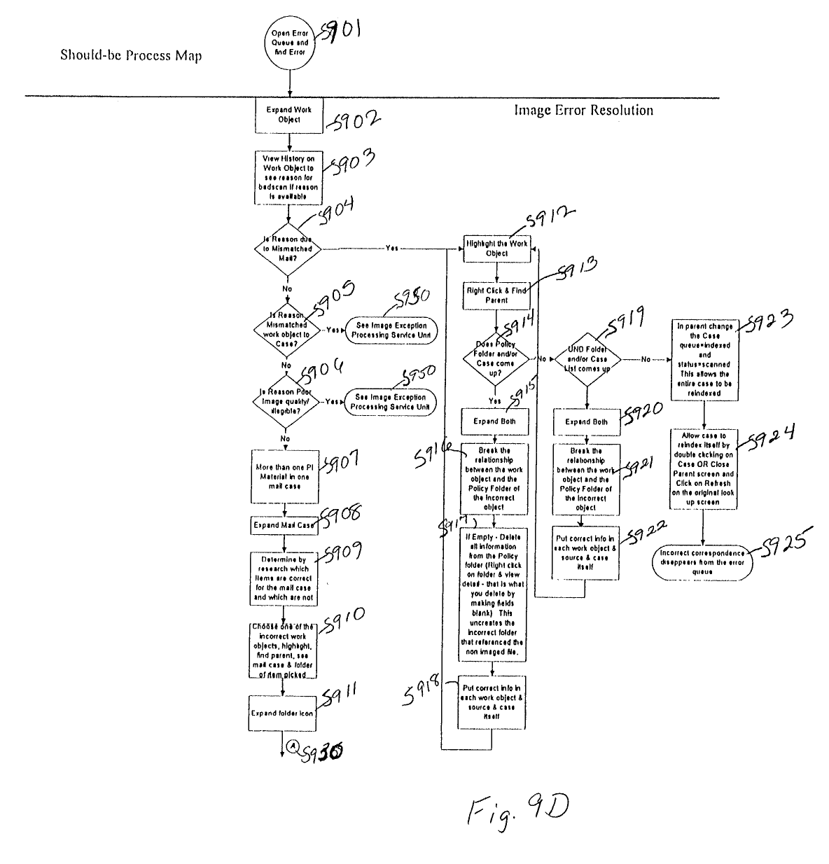

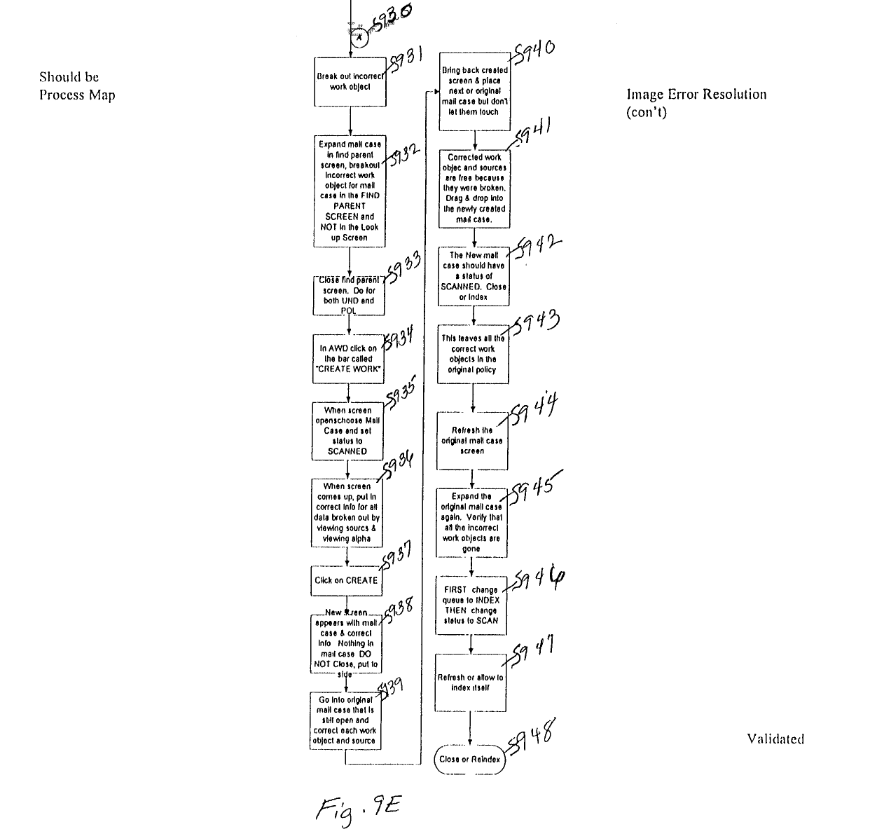

The document formats 124 (FIG. 4) are preferably a list of the document types with which the Imaging System is designed to operate. The list of document types is preferably provided to the entity in table format, as shown in FIGS. 10A-10D, which are tables of document types involved in the processing of a new insurance application. The tables preferably include a first column 1000 that lists a type of document, a second column 1010 that defines a document type 1010, a third column 1020 that lists examples of information included in the document type, and a fourth column 1040 that lists proposed file names for each imaged document type.

As shown in FIG. 11, a control component 1130 preferably comprises a plurality of contingency guidelines 1132 and a reporting component 1134. The contingency guidelines 1132 are generally step-by-step instructions for handling various types of errors and situations that may be encountered during the regular course of business while using the Imaging System. The reporting component 1134 generally provides a plurality of reports on a plurality of performance factors relating to the Imaging System.

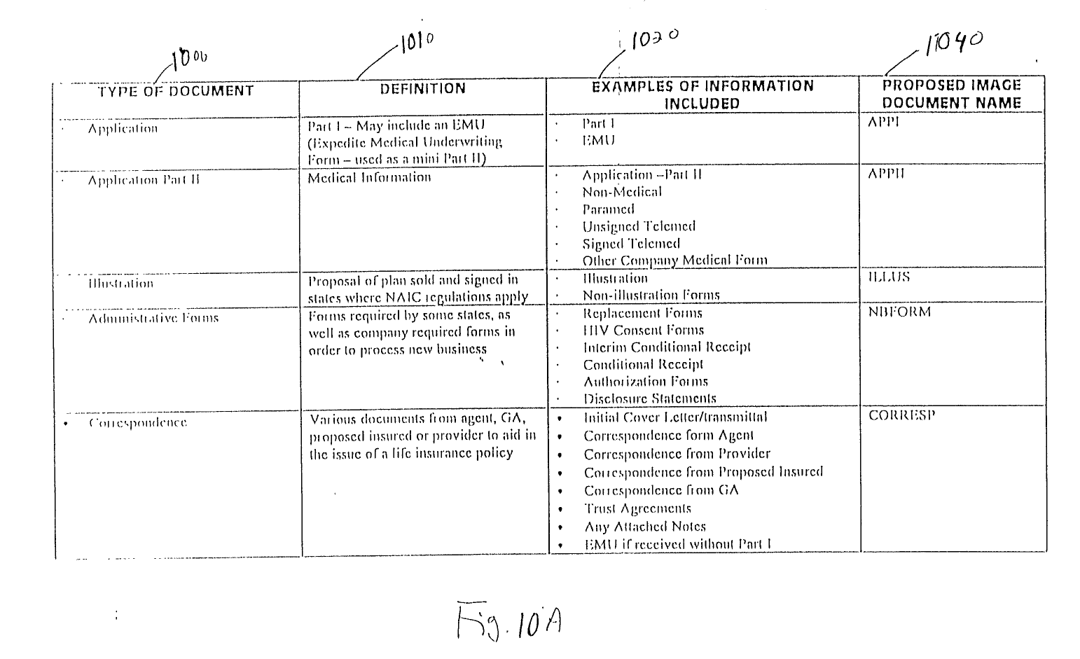

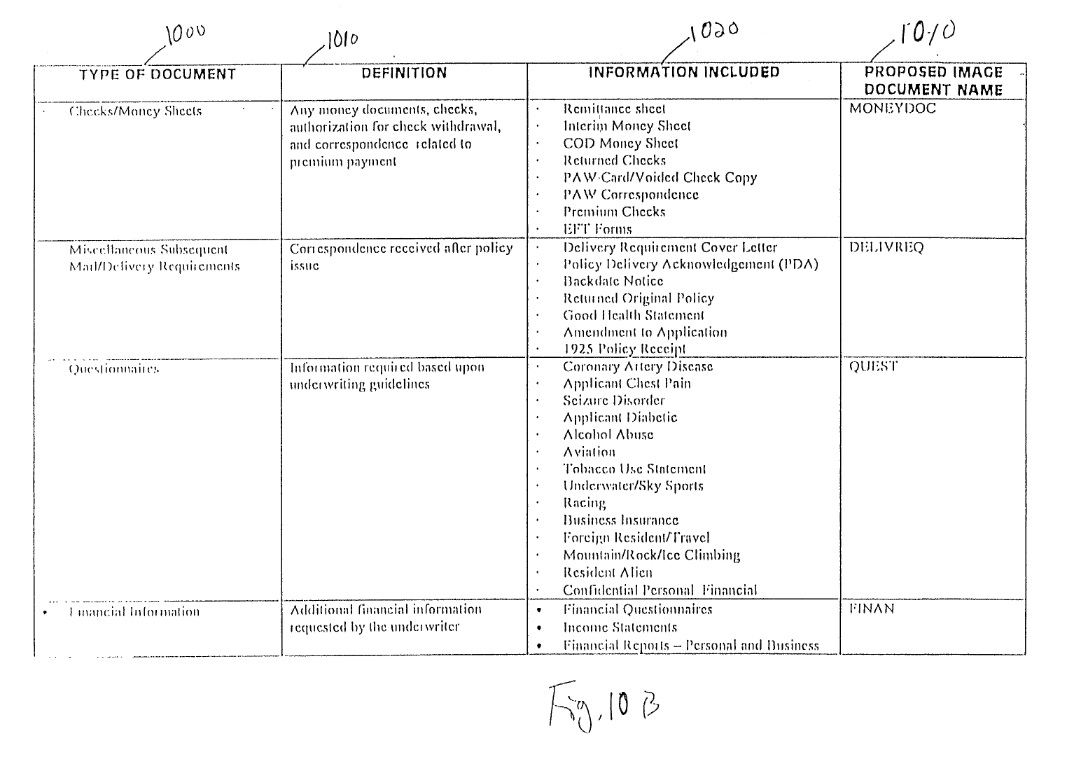

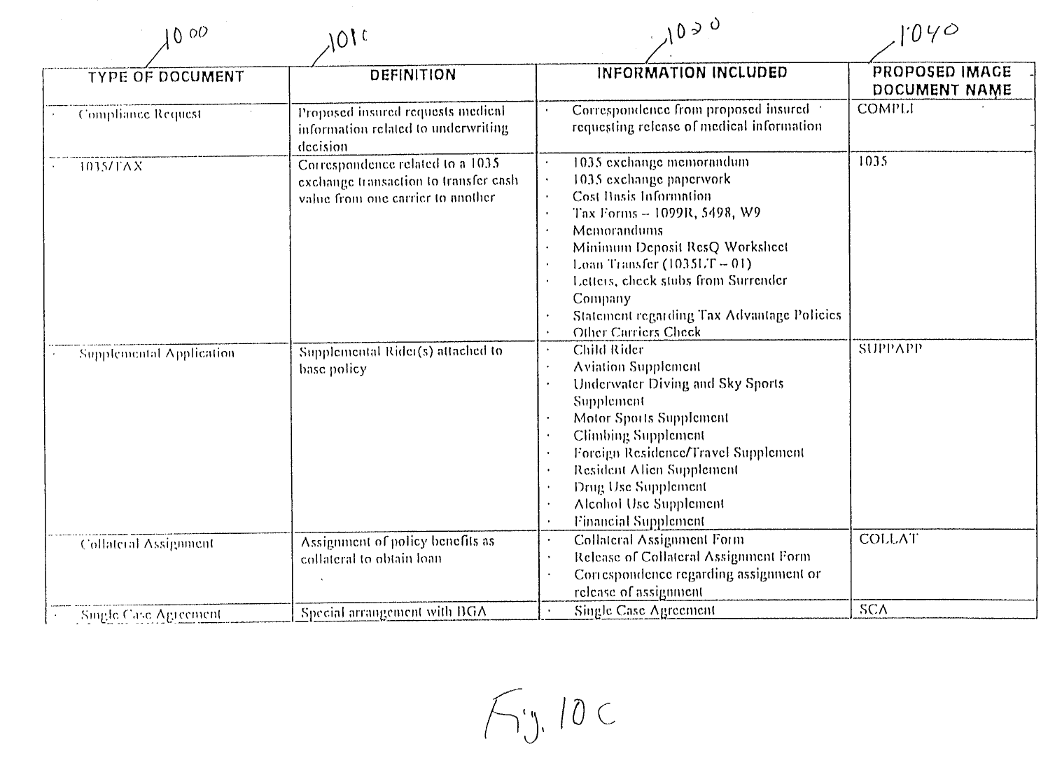

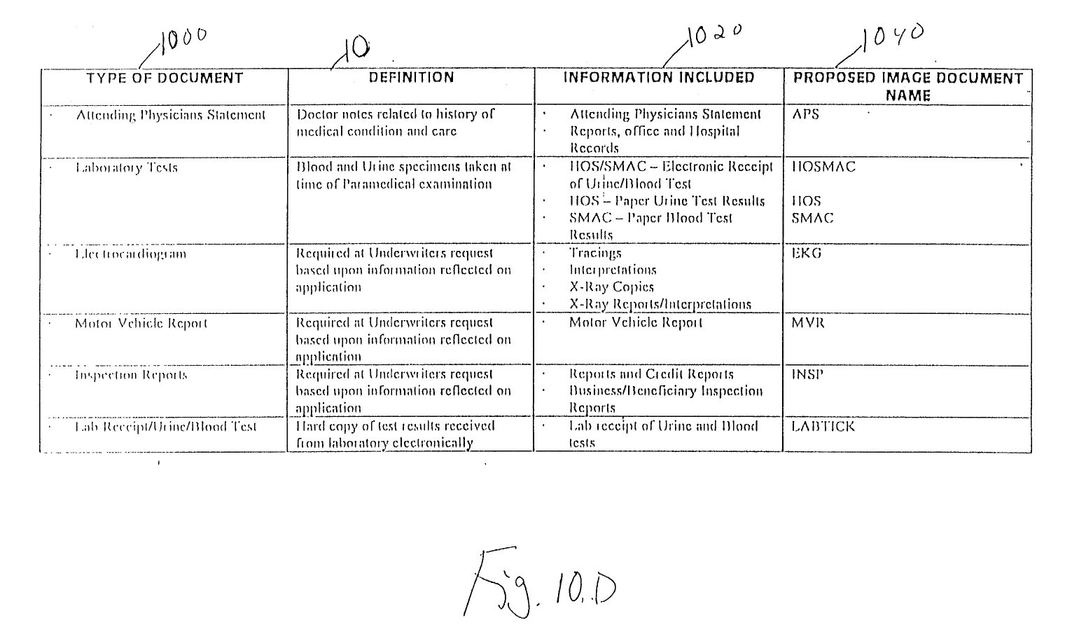

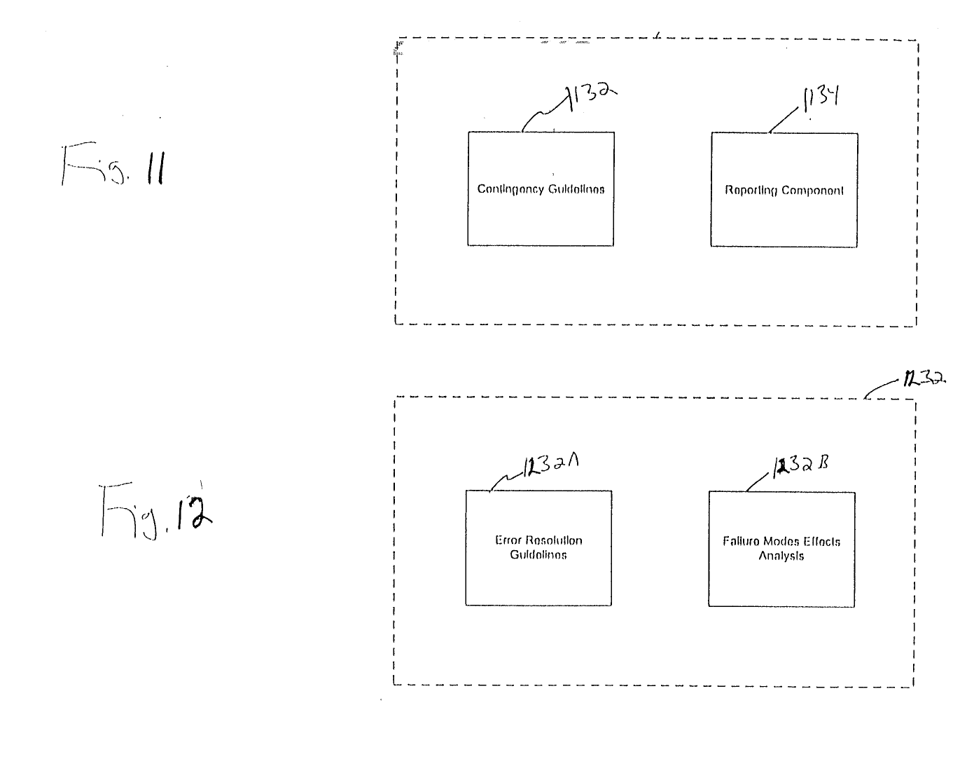

As shown in FIG. 12, the contingency guidelines 1132 preferably comprise a plurality of error resolution guidelines 1232A and a failure modes effects analysis (FMEA) 1232B. The error resolution guidelines 1232A are preferably provided in table form, as shown in FIGS. 13A-13D, which are tables of error resolution guidelines 1232A for an insurance broker or agent. The error resolution guidelines 1232A provide solutions for handling each of the various possible errors that may occur in the use of the Imaging System. The tables of error resolution guidelines 1232A preferably include a first column 1300 that lists possible errors, a second column 1310 that lists a person or a team responsible for identifying a particular error, a third column 1320 that lists a person or team responsible for resolving the particular error, a fourth column 1330 that lists possible ways to resolve the particular error, a fifth column 1340 that lists the type of communication to be used to report the particular error, a sixth column 1350 that lists preferred timeframes for resolving the particular error, and a seventh column 1360 that lists a person or a team responsible for confirming that the particular error was corrected.

As an illustrative example, if an imaged document is illegible, an item 1 in FIG. 13A may be referred to for a recommendation of a resolution for such an error. According to item 1, a Quality Assurance team can be tasked with resolving errors of this type (as shown in column 1310). In such a situation, the insurance provider to whom the illegible imaged document was transmitted will notify the entity that an illegible imaged document situation has occurred (as indicated in column 1330). According to the recommended resolution guidelines 1232A, following receipt of the error notification, the entity should re-scan the entire original paper document, resulting in a new imaged document as indicated in column 1330. The entity should then transmit the new imaged document to the insurance provider. Upon receipt of the transmitted new imaged document, the insurance provider should notify the entity of a legibility status of the new imaged document.

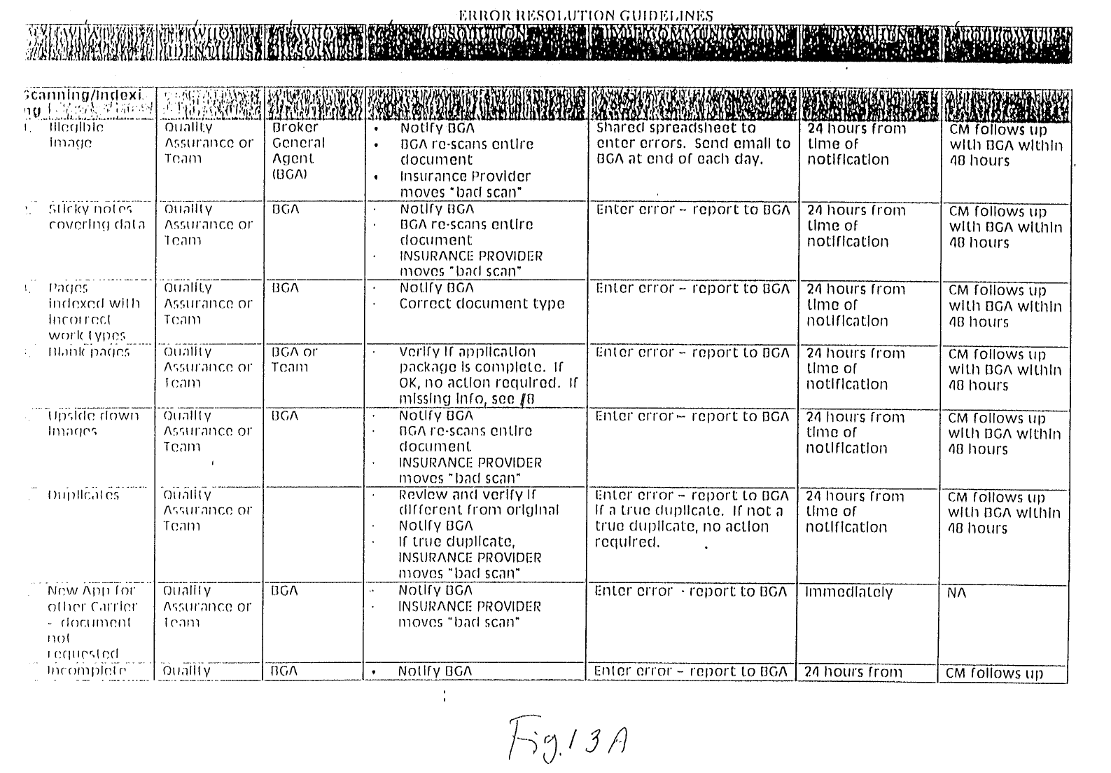

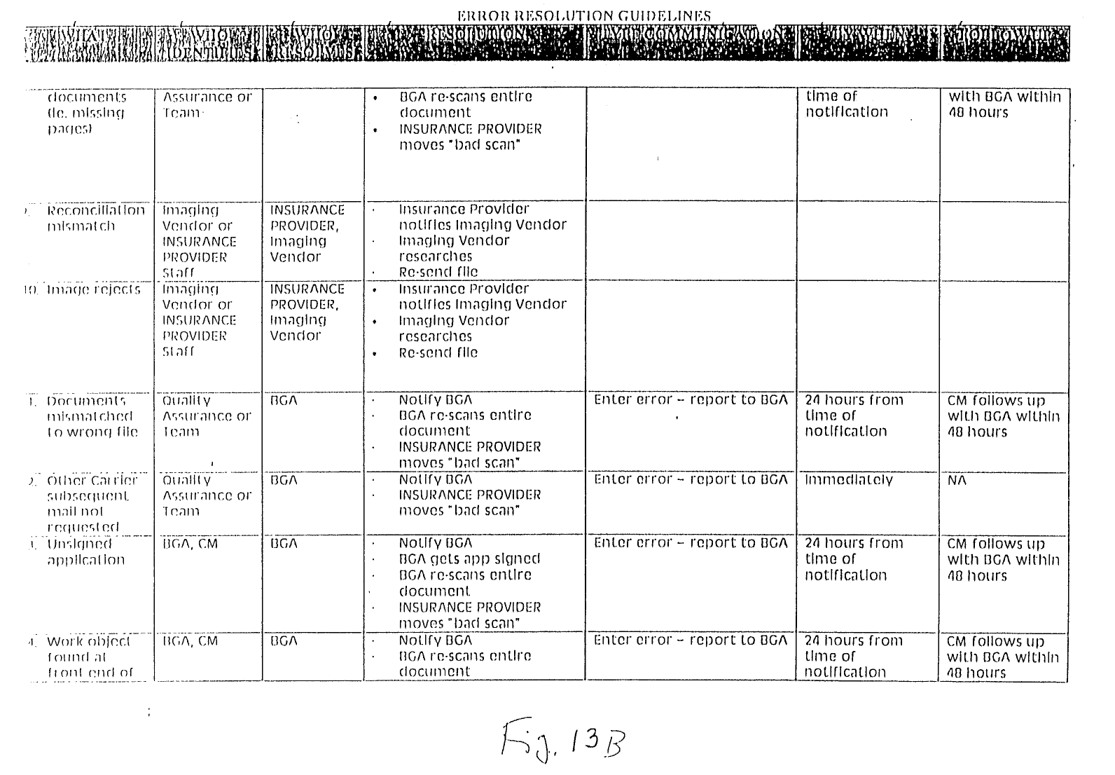

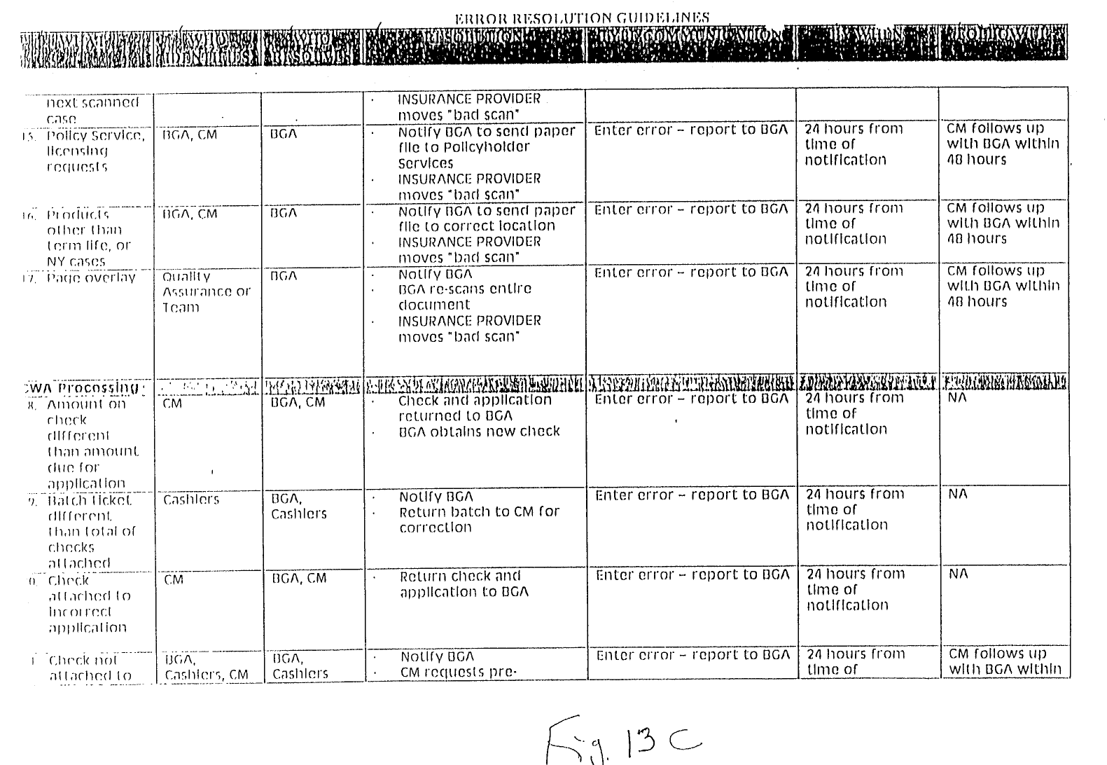

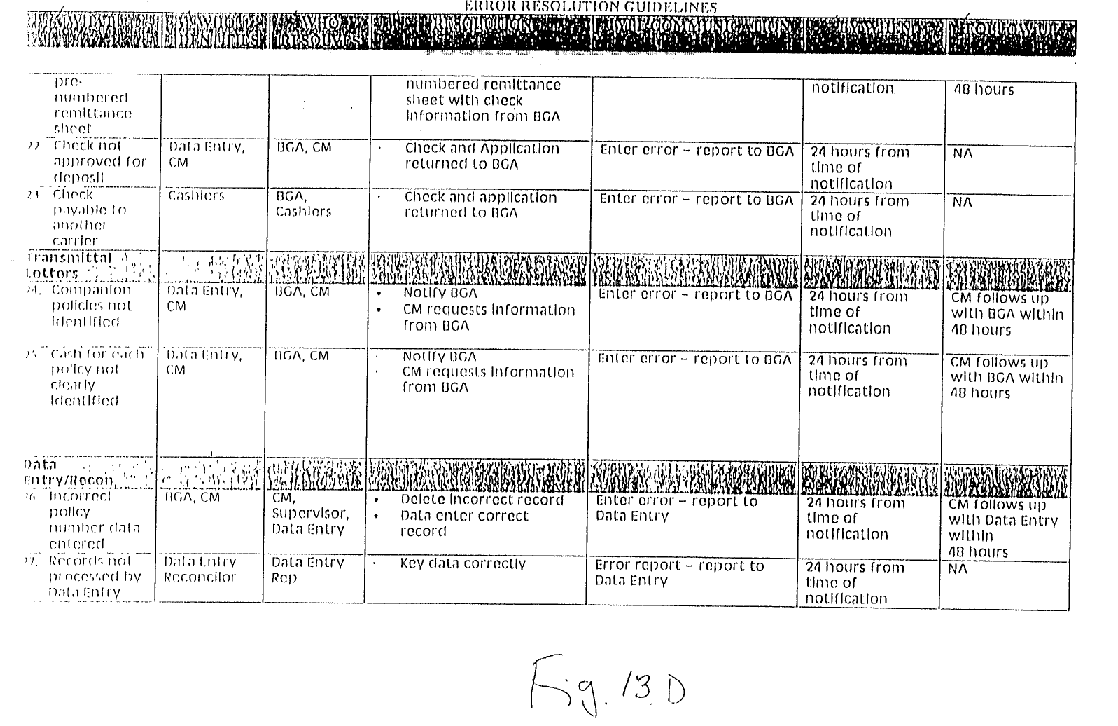

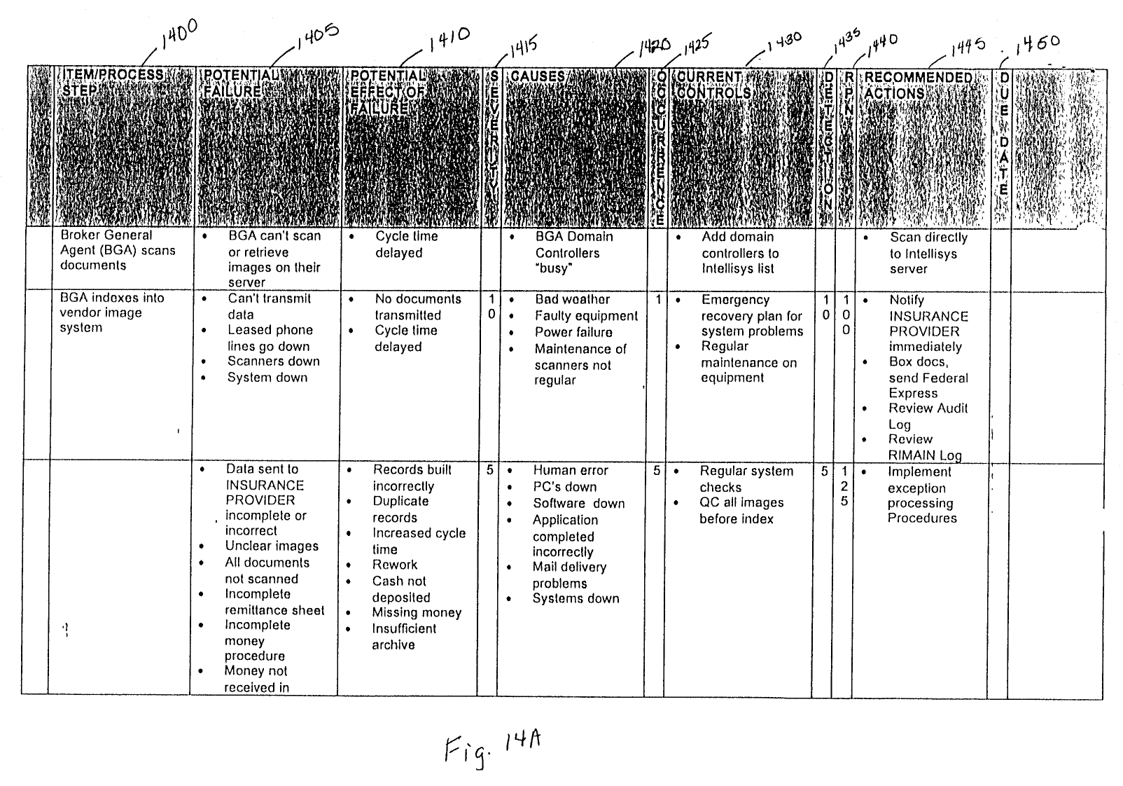

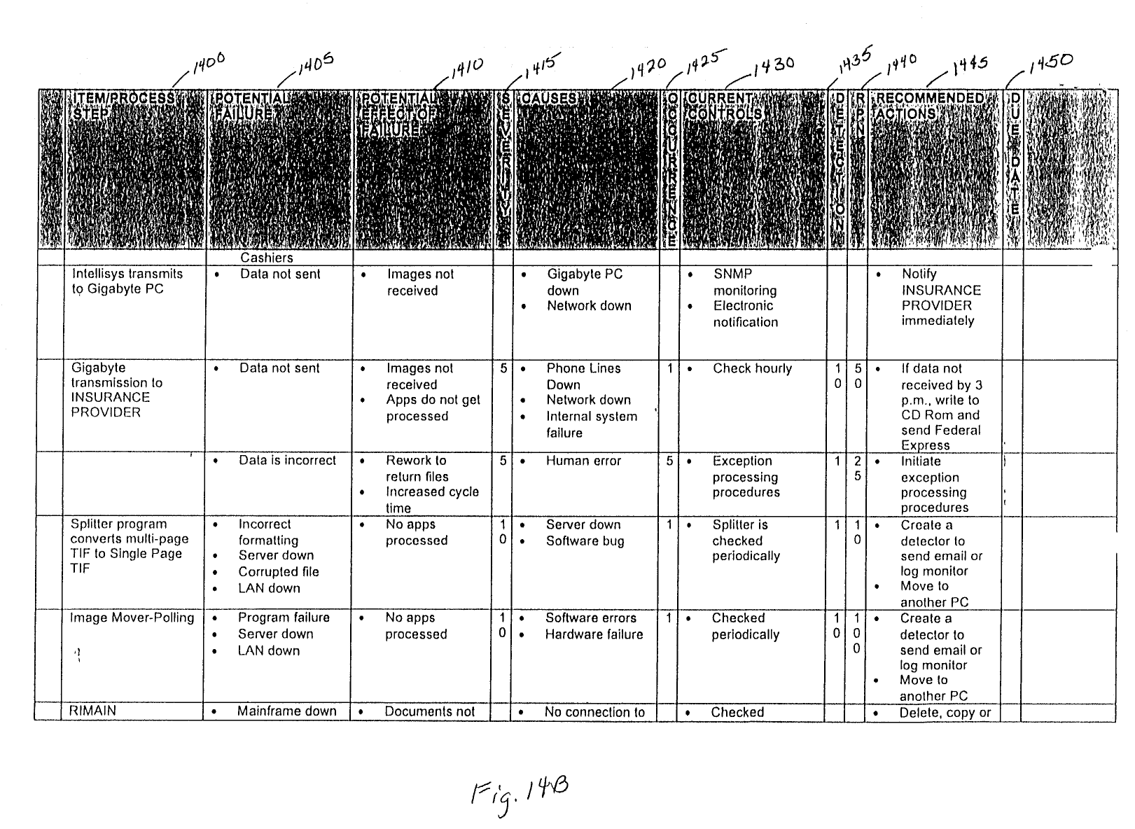

The FMEA 1232B is preferably also in table form, as shown in FIGS. 14A-14G, which are tables listing a plurality of possible failure modes of the Imaging System, a plurality of possible causes for each possible failure mode and one or more recommended actions to take to resolve such failure modes. The tables preferably include a first column 1400 that identifies an item or a process step that could fail, a second column 1405 that identifies a potential failure associated with such item or process step, a third column 1410 that identifies a potential effect of the identified failure, a fourth column 1415 that holds a value that corresponds to a severity of the identified failure, a fifth column 1420 that lists a plurality of possible causes of the identified failure, a sixth column 1425 that holds a value that corresponds to a likelihood of the identified failure occurring, a seventh column 1430 that lists a plurality of current procedures (controls) that are in place to prevent the identified failure, an eighth column 1435 that holds a value that corresponds to a detectability of the identified failure, a ninth column 1440 that holds a value (called a Risk Priority Number or RPN) that is derived by multiplying the numbers in columns 1415, 1425 and 1435, a tenth column 1445 that lists recommended actions for correcting the identified failure, and an eleventh column 1450 for optionally listing a preferred amount of time for correcting the identified failure.

In the example illustrated in FIGS. 14A-14G, the severity numbers in column 1415 and the occurrence numbers in column 1425 are higher as the potential severity and the likelihood of the failure occurring, respectively, increase. The detection number in column 635 is higher as the difficulty of detecting the failure increases. The RPN number is derived by multiplying the severity, occurrence, and detection numbers in columns 1415, 1425 and 1435, respectively. The RPN number serves as an indicator of a seriousness of the identified failure.

The various documents, tables and/or databases that make up the planning component 110, the implementation component 120, and the control component 130 may be provided to the entity in electronic form, e.g., as computer files, or may be delivered in hard copy form to the entity. If the components 110, 120 and 130 are provided in electronic form, they may be provided on a computer storage medium, for example, a portable computer storage medium, such as a CD ROM, a writable optical disk, a floppy disk, or the like.

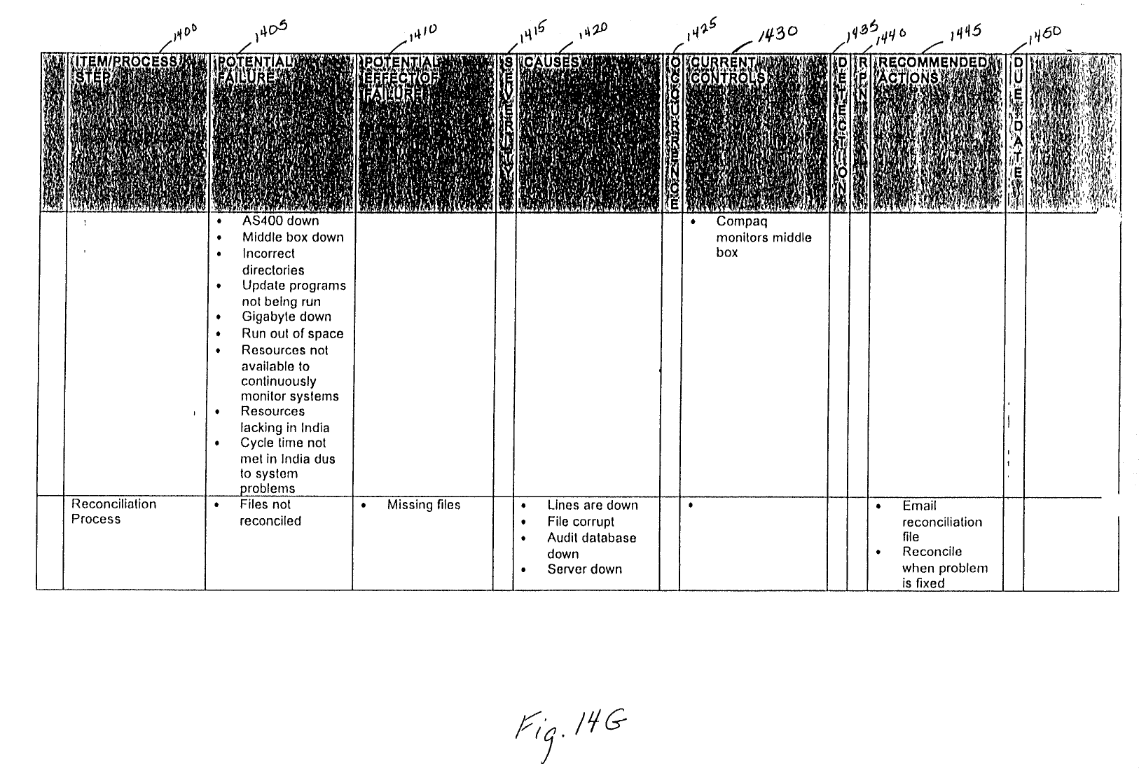

FIG. 16 is a flowchart illustrating a plurality of steps conducted in a method for implementing the Imaging System, in accordance with the present invention. At step S1600, the entity is provided with information about the Imaging System. As discussed above, the information is preferably in the form of FAQs about the Imaging System.

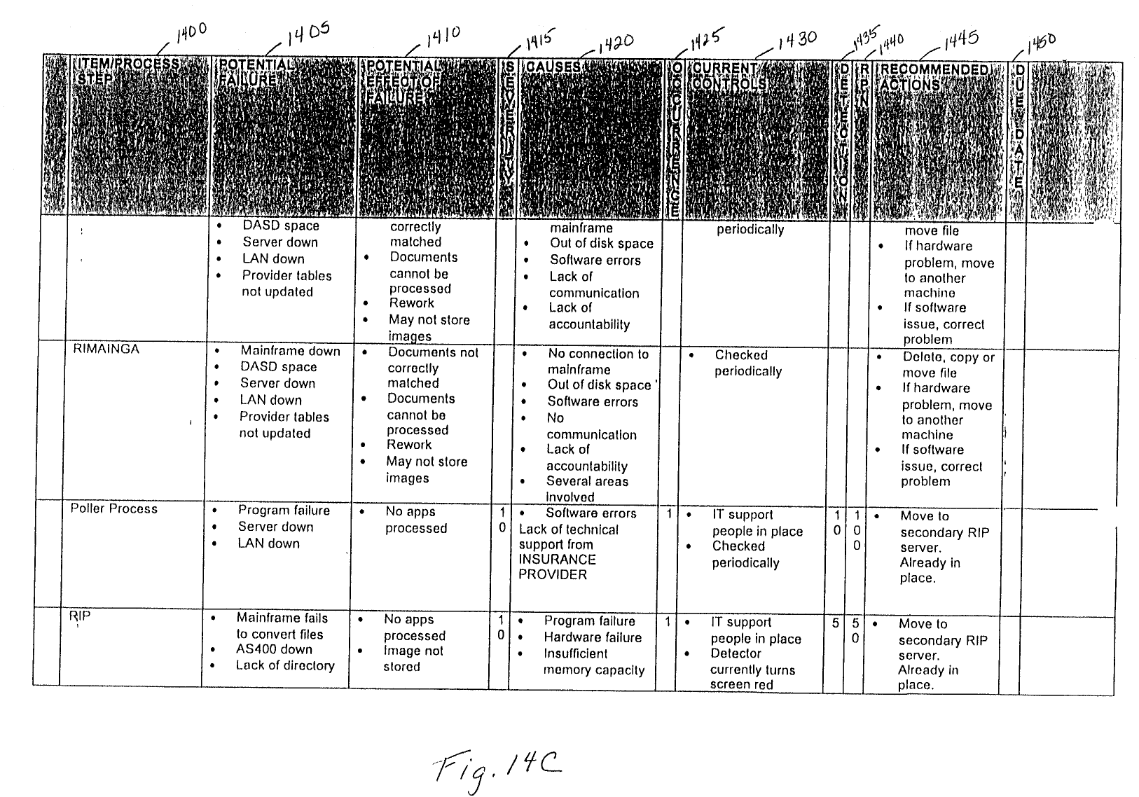

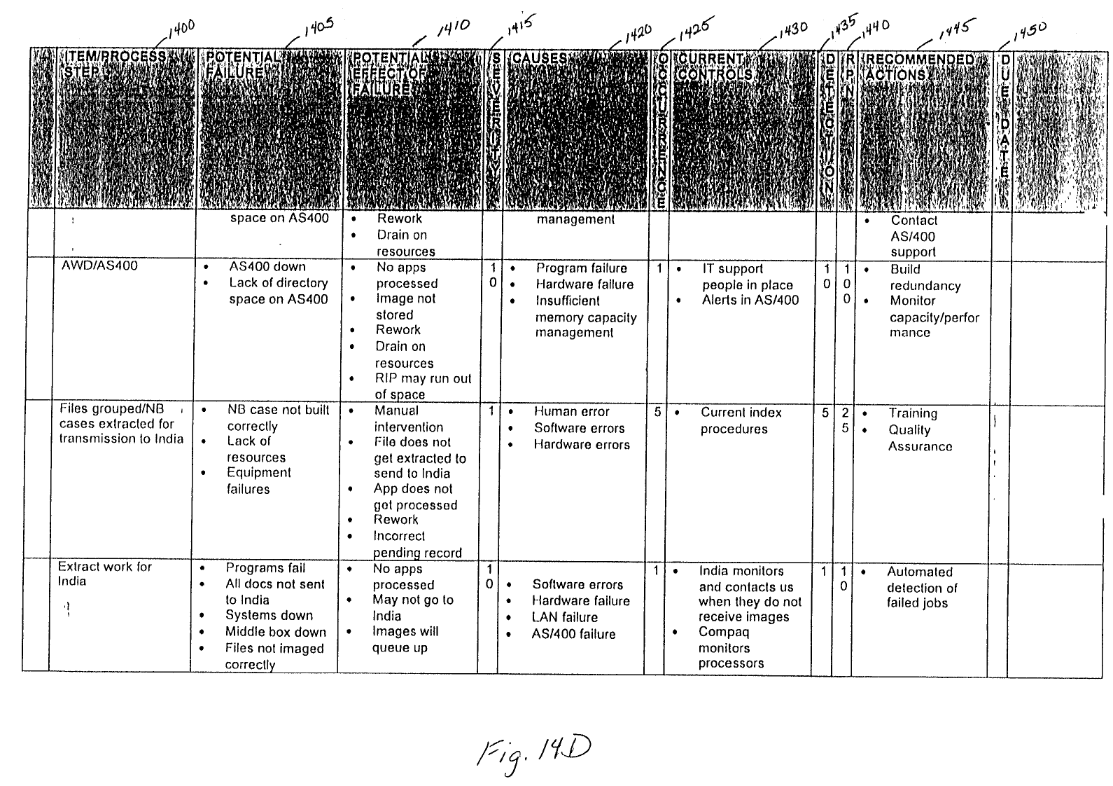

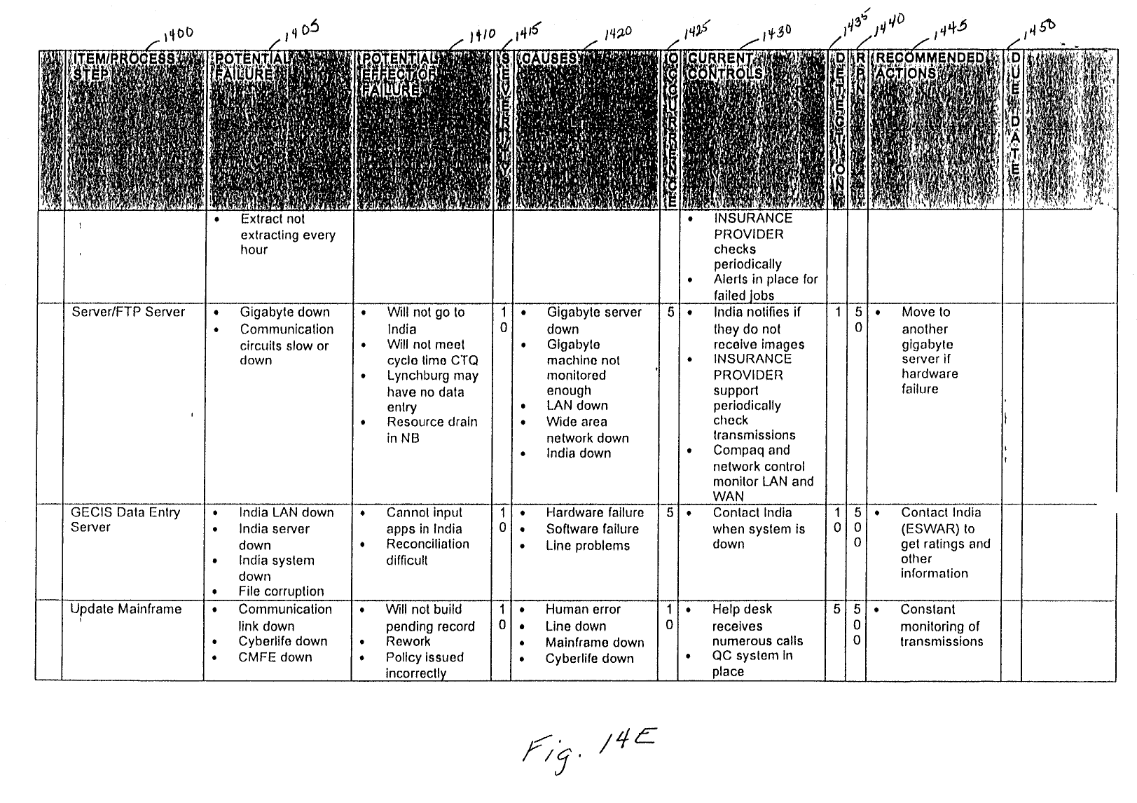

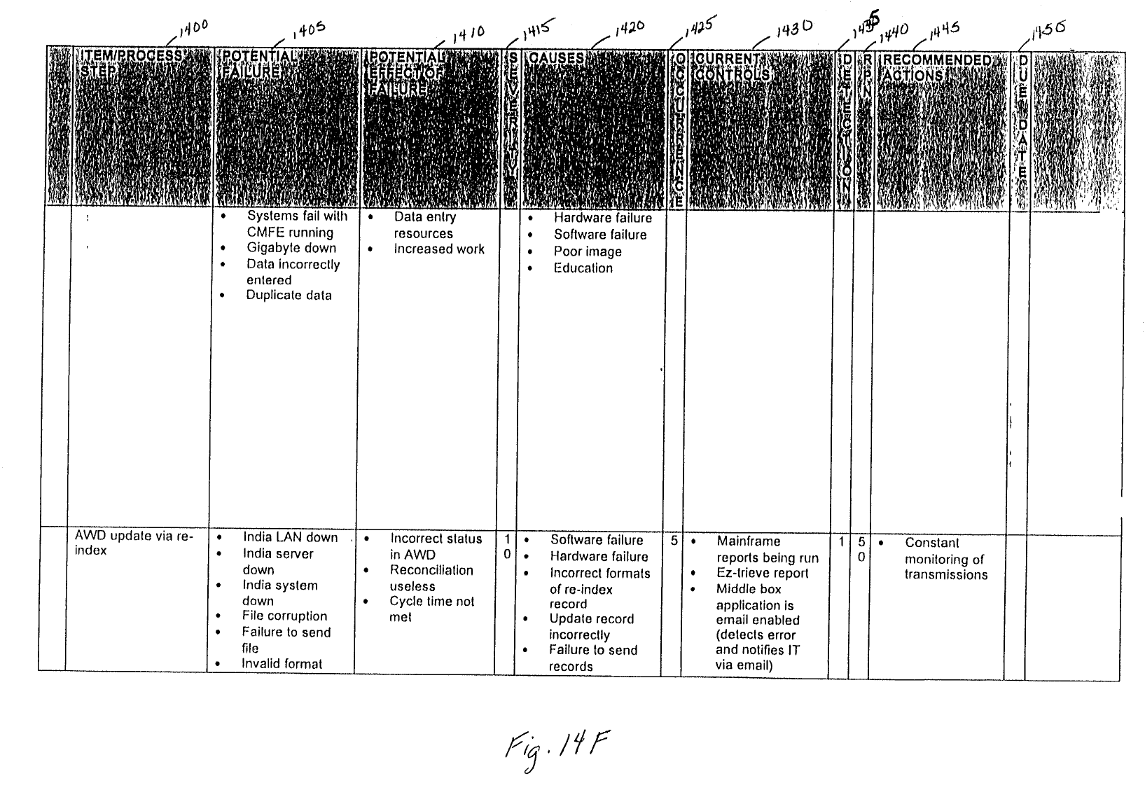

FIG. 15A illustrates plurality of alterations to an application form 1500. The alterations to the application form 1500 may include policy number, completed by, and date. The application form 1500 may also include a plurality of check boxes indicating whether the application form 1500 is a copy or a faxed copy, if any signatures are not in original ink, if any signatures are rubber stamped, if the application form 1500 is in pencil, or if any signatures are altered. The application form 1500 may also include a plurality of check box fields indicating if any notations are altered or are not initialed, if any correction fluid has been applied to the application form 1500, and if so, where, if any highlighters have been applied to the document and where, if different colored inks have been used and where, and if there are any other unusual or questionable qualities of the application form 1500. Some or all of these check box fields may include a free form field for inputting comments or descriptions. The application form 1500 may also include a free form comments field.

FIGS. 15B-15E illustrate a quality review log generated by the application form 1500, which may be used to keep records of quality problems related to the image system. The quality review log may list a plurality of possible errors of documents in the Imaging System, a policy number, one or more errors found, a responsible person, and one or more related comments for each of the plurality of possible errors. The plurality of possible errors may include agent related errors, CWA errors, barcode errors, and scanning errors.

The quality review log preferably includes a first column 1501 that identifies an item being reviewed or errors, a second column 1502 that identifies a policy number of the item being reviewed, a third column 1503 representing whether an error was found or not, and a fourth column 1504 identifying a person responsible for the error. The quality review log may also include a comments field 1505 for entering comments relating to the items being reviewed such as the errors.

The agent related errors may include whether a document is a copy or a faxed copy, if any signatures are not in original ink, if any signatures are rubber stamped, if the document is in pencil, if any signatures are altered, if any notations are altered and not initialed, if any correction fluid has been applied to the document and, if so, where, if any highlighting has been applied to the document and, if so, where, if different colored inks have been used and, if so, where, if any other unusual or questionable qualities exist, if the agent's name was printed on part one for an application before imaging, if there was bad scan, if a check amount is different than a policy premium, if a check is attached to a wrong policy, if a check is payable to an incorrect carrier, and if companion cases are not correctly identified. CWA errors may include check specifications that have not been met such as when a signature of a drawer of a check is not on the check, a check is not made payable to a correct entity, if a check endorsed to the entity does not have a handwritten signature and a title of the signer of the check. If the written and numeric amounts on a check do not agree, if all changes on a check are not initialed, if a check is post-dated, if a signature is incomplete, and/or if a check has not followed anti-money laundering processes.

Preparation related errors may include situations where an application is not prepared in numerical order, if each work type bar code does not match the document, if a document page count is not written at a predetermined place, if the corners are folded, if staples and paper clips have not been removed, if post-it notes are covering text, and/or if the pages sections and bar codes are not prepared in a correct orientation such as facing forward and right-side up. Bar code errors may include situations where a last name, a first name, a date-of-birth, and a policy number is not entered correctly, or where a company code is not correct. Scanning errors may include situations where a case, a folder, a work object or a source object has not been created, where documents are placed in a policy folder that are not for the policy folder only, where there are bleed through or blank pages in a document, where the pages not straight, where the pages have folded corners, covered text, or vertical black lines that are not on the original document, where there are page overlays, imaged bar codes, missing sections, missing pages, and/or duplicate sections.

At step S1610, information is obtained from the entity about the entity's existing document handling and delivery system. As discussed above, this information may be obtained by providing the entity with a survey for the entity to complete and return to a provider of the survey.

At step S1620, the entity is provided with the process maps, documents formats and contingency guidelines for the Imaging System, as explained above. At step S1630, feedback is provided to the entity regarding the performance of the Imaging System in the form of an immediate notification of certain types of errors, as discussed above. At step S1640, performance reports are provided to the entity.

FIG. 17 is a flowchart of an embodiment of a method for implementing the performance report providing step (step S640) of FIG. 16. As shown in FIG. 17, at step S1742, the performance of the Imaging System is monitored by monitoring any errors that occur in the Imaging System. At step S1744, performance reports are generated and sent to the entity based on the information gathered at step S1742.

Sample FAQs relating to an Imaging System, referred to above with reference to FIG. 2, may include:

Q I don't currently have an image system in my office but want to take advantage of this process. How can I get started ?

A There are many ways to implement image processing in your office, from having a total Imaging System in your facility to using imaging services from a provider. We can supply names of various imaging vendors that we work with, or you can conduct your own search. We will also send you our Imaging Solutions Guide. This guide provides an overview of what it takes to use an Imaging System for transmitting documents to us. In addition, one of our Team Leaders will help you complete our client survey to evaluate your existing document handling and delivery systems and processes and technology and gain an understanding of your expectations.

Q If I implement an Imaging System for your imaging process, can I use the Imaging System for transmitting imaged documents to other insurance carriers?

A The process is designed to be image system independent; that is, we accept transmitted images from various Imaging Systems that can provide the format we need. This means that the Imaging System you have installed at your site can be used for internal purposes as well as for other insurance carriers.

Q Will I have to purchase new equipment to take advantage of this new process?

A If you don't currently have an image system, you will need equipment to allow for scanning and storing of paper documents and files, and communications equipment for transmitting the imaged documents to us. You may also be required to update your existing workstations, depending on your vendor's technical requirements.

Q I have an existing Imaging System implemented in my office. Can I just use what I have, or will I have to purchase new equipment?

A Our imaging solution is designed to work with many different Imaging Systems, and we would be happy to analyze your current system for compatibility. You may have to purchase additional equipment in order to transmit the imaged documents to us if you don't already have this capability.

Q Can I use my existing document types, indexing schemes, and scanning procedures?

A The Imaging Solutions Guide provides information on NAILBA standards for imaged document types. We will be happy to meet with you to review how other clients have implemented an imaging solution.

Q OK, give me the facts. Is this imaging process really better than simply mailing in the paper-based documents? Why do I want to do this?

A Both the insurance carrier and the client can benefit from the reductions in costs and cycle times provided by Imaging Systems. An imaging solution can immediately reduce processing cycle time by the 1½ days or more normally required for mailing paper documents. This is coupled with a total reduction in misplaced or lost files after they reach the insurance carrier, and a decrease in shipping costs. Plus, with imaging, we can provide automatic receipts and our case managers have up-to-the minute status on new cases. We have testimonials from clients who have implemented an imaging solution and can make these available to you upon request.

Q What services do you offer for setting up an Imaging System?

A We will assign a dedicated Team of IT and Business resources to assist you through implementation and execution of an Imaging System.

Q Will you train my staff?

A Members of your staff will be invited to participate as Team members, and will become familiar with the image process. You have the option of having the insurance carrier and imaging vendor train your staff or you may choose to have team members from your office train your staff.

Q How do I transmit the imaged documents to you?

A Currently, our clients are transmitting imaged documents to us via dedicated communication lines. A number of these are using VPN's (virtual private networks) that are associated with the Imaging System vendor.

Q What will this cost me?

A There may be costs associated with purchasing and setting up Imaging System equipment, as well as any costs paid to the imaging vendor. However, the benefits of reduced mail expenses and cycle time far outweigh the costs.

Q How long will it take to implement and execute an Imaging System for me?

A Depending on the imaging vendor and the imaging equipment needed, it can take anywhere from 30 to 120 days.

Q What resources are needed at my end to set this Imaging System and process up?

A We have found through experience that it is best if you have a dedicated person assigned to the project team. This person will be involved in all team meetings, and will become your in-house expert. We will assign a Project Leader who will lead the team through the implementation process and will keep you informed on the progress of the implementation.

Q Exactly what documents do you need for me to scan and transmit to you?

A This question will be answered during a period where we evaluate your requirements prior to starting the Imaging System implementation.

Q Will this Imaging System also be capable of handling documents other than applications, such as address changes, beneficiary changes, and other insurance policy service transactions documents?

A During the requirements evaluation period, the team will obtain an understanding of the scope of the implementation project. If the goal is to transmit all of your documents in imaged format, the implementation will include document types for all insurance policy service transaction documents.

Q If I'm scanning and transmitting application documents to you, what do I do with the originals of the scanned, transmitted documents?

A Our goal is to eliminate the need to receive original documents on a daily basis. Guidelines for handling original documents are included in our Imaging Solutions Guide.

Q Will I be required to sign a contract for this arrangement?

A You will enter into a separate contract with the imaging vendor and with us.

Q What happens when problems with my Imaging System occur? Do you simply fix them, or do we have to start over?

A The Project Team has experience in dealing with imaging and related projects and will be available to assist when problems occur. In addition, documents that outline a number of risk factors and potential solutions are found in the Imaging Solutions Guide.

Q The Imaging System you propose is not compatible with those Imaging Systems used by our other insurance carriers. Since we don't want two Imaging Systems, what can you do?

A We are primarily interested in receiving the imaged documents and accompanying data in a format required by our Imaging Systems here. We can analyze the format your Imaging System is capable of transmitting and check for compatibility. Custom programming may be necessary in order for us to receive your imaged documents in the most efficient manner.

Q How much will use of an Imaging System speed up the insurance application approval process?

A Cycle time will be improved by a minimum of 3 to 5 days, and, as teams become more familiar with the imaging process, cycle time may improve by up to 10 days.

Q What type of scanner do I need?

A Scanning equipment must be compatible with the Imaging System you have or are installing. The type of scanning equipment recommended will also be dictated by your anticipated use of the Imaging System and volumes of documents involved.

Q How fast should my scanner be?

A This will depend on the volume of insurance applications and paper files you expect to scan. Your Imaging System vendor should be able to offer specific recommendations based on your business plans, processes, and forecasts.

Q What is this I'm hearing about a duplex scanner?

A Scanning equipment is available in both simplex (one document side scanned) and duplex (both document sides scanned) models. For high scanning volumes that process a large percentage of forms printed on both sides of the paper, duplex scanners may be a worthwhile investment.

Q Is my transmitted imaged data secure?

A We use a private network to transmit imaged data between the imaging vendor and our production center. We cannot guarantee data security between the customer and the imaging vendor/intermediary.

Q If I use an Imaging System for all insurance carriers, how can I be sure that the right imaged documents get to the right insurance carrier?

A Your Imaging System will probably need custom software in order to transmit imaged documents to multiple insurance carriers. Your Imaging System vendor should be able to help you with this issue. In addition, effective quality controls, and exception processing is necessary with all insurance carriers to help ensure the imaged documents get to the appropriate parties.

Q Can I use the Imaging System for documents that are not sent to an insurance carrier?

A This depends on the individual implementation of the Imaging System at your business, and how you have the configured the Imaging System to handle different documents.

Q What types of problems have been experienced with this imaging process?

A We follow rigorous project management principles when implementing a new imaging process. While each imaging process may be slightly different, the learning from past projects are known and shared to mitigate any anticipated problems.

Q I have multiple offices across the country. What options do I have?

A The preferred method would be to have a central imaging processing center to ensure consistency. However, we can accommodate multiple imaging processing centers depending on customer preference and cost.

Q What do I do with CWA and checks?

A Checks will be imaged with the application documents, and procedures for CWA and COD (charge on delivery) our included in our Imaging Solutions Guide.

While this invention has been described in conjunction with the specific embodiments outlined above, it is evident that many alternatives, modifications and variations will be apparent to those skilled in the art. As discussed above, although the present invention has been described in the context of implementing an Imaging System for processing insurance applications and related documents, it is applicable to any type of document and can be used by any entity that would like to implement an image-based document handling and delivery system. Further, although specific examples of formats for the information provided to and obtained from the entity have been provided (e.g., formats for the survey, error resolution guidelines, FMEA, and FAQs), other formats can be used while still falling within the scope of the present invention. Accordingly, the embodiments of the invention as set forth above are intended to be illustrative, not limiting. Various changes may be made without departing from the spirit and scope of the invention as defined in the following claims.

What is claimed is:

1. A system for implementing an image-based document handling and delivery system comprising:
a planning component that gathers information about an infrastructure, a current document handling and delivery system and a methodology used by an entity;
an implementation component that provides the entity with a plurality of process maps that provide a plurality of step-by-step instructions for executing the image-based document handling and delivery system; and
a control component that provides the entity with a plurality of contingency guidelines and procedures for monitoring and maintaining performance of the executed image-based document handling and delivery system
wherein the contingency guidelines and procedures for monitoring and maintaining performance of the executed image-based document handling and delivery system include quality review procedures.

2. The system of claim 1 wherein the quality review procedures comprise at least one quality review form for indicating one or more quality problems.

3. The system of claim 1 wherein the quality review procedures comprise a quality review error log for recording one or more image-related errors.

4. The system of claim 3 wherein the image-related errors comprise at least one of a group including of a plurality of agent related errors, a plurality of preparation related errors, a plurality of barcode-related errors, and a plurality of scanning related errors.

5. A system for implementing an image-based document handling and delivery system comprising:
a planning component that gathers information about an infrastructure, a current document handling and delivery system and a methodology used by an entity;
an implementation component that provides the entity with a plurality of process maps that provide a plurality of step-by-step instructions for executing the image-based document handling and delivery system; and
a control component that provides the entity with a plurality of contingency guidelines and procedures for monitoring and maintaining performance of the executed image-based document handling and delivery system;
wherein the process maps of the implementation component include at least one of a document specific process map dependent on a document type to be processed and a location specific process map dependent on a location of the document to be processed.

6. The system of claim 5 wherein the document specific process maps comprise a document-specific process map of the entity's existing document handling and delivery system and a document specific process map for at least a portion of the image-based document handling and delivery system.

7. The system of claim 5 wherein the document specific process maps comprise at least one of a group including a new application processing map, a pull and attach document processing map, and a delivery requirements processing map.

8. The system of claim 5 wherein the location specific process maps comprise at least one of a group including a mail and copy room process map, a sales team process map, a branch team process map and an image team process map.

9. The system of claim 8 wherein the image team process map comprises at least one of a group including a document imaging process map, an image work flow process map, a policy building process map and an image error resolution process map.

10. The system of claim 5 wherein the location specific process map comprises a location specific process map of the entity's existing document handling and delivery system and a location specific process map for at least a portion of the image-based document handling and delivery system.

11. A method of implementing an image-based document handling and delivery system, comprising the steps of:
gathering information about an entity's existing document handling and delivery system;
providing the entity with at least one process map for executing the image-based document handling and delivery system; and
providing the entity with a plurality of guidelines and procedures for monitoring and maintaining performance of the image-based document handling and delivery system;
wherein the step of providing the entity with at least one process map includes providing one of a document specific process map dependent on a type of document being processed and a location specific process map dependent on a location the document is being processed.

12. The method of claim 11 wherein the step of providing the entity with at least one of the document specific process map comprises providing a document-specific process map of the entity's existing document handling and delivery system and a document specific process map for at least a portion of the image-based document handling and delivery system.

13. The method of claim 11 wherein the document specific process maps comprise at least one of a group including a new application processing map, a pull and attach document processing map, and a delivery requirements processing map.

14. The method of claim 11 wherein the step of providing the location specific process map comprises providing at least one of a group including of a mail and copy room process map, a sales team process map, a branch team process map and an image team process map.

15. The method of claim 14 wherein the step of providing the image team process map comprises providing at least one of a group including of a document imaging process map, an image work flow process map, a policy bulding process map and an image error resolution process map.

16. The method of claim 11 wherein the step of providing the location specific process map comprises providing a location specific process map of the entity's existing document handling and delivery system and a location specific process map for at least a portion of the image-based document handling and delivery system.

17. A method of implementing an image-based document handling and delivery system, comprising the steps of:
gathering information about an entity's existing document handling and delivery system;
providing the entity with at least one process map for executing the image-based document handling and delivery system; and
providing the entity with a plurality of guidelines and procedures for monitoring and maintaining performance of the image-based document handling and delivery system;
wherein the step of providing the entity with the guidelines and procedures for monitoring and maintaining performance of the image-based document handling and delivery system includes providing a plurality of quality review procedures.

18. The method of claim 17 wherein the step of providing the quality review procedures comprises providing at least one quality review form for indicating one or more quality problems.

19. The method of claim 17 wherein the step of providing the quality review procedures comprises providing a quality review error log for recording one or more image-related errors.

20. The method of claim 19 wherein the image-related errors comprise at least one of a group including a plurality of agent related errors, a plurality of preparation related errors, a plurality of barcode-related errors, and a plurality of scanning related errors.

21. Means for implementing an image-based document handling and delivery system, comprising:
means for gathering information about an entity's existing document handling and delivery system;
means for providing the entity with at least one process map for executing the image-based document handling and delivery system; and
means for providing the entity with a plurality of guidelines and procedures for monitoring and maintaining performance of the image-based document handling and delivery system;
wherein the means for providing the at least one process map includes means for providing one of a document specific process map dependent on a type of document being processed and a location specific process map dependent on a location where the document is being processed.

22. The means of claim 21 wherein the means for providing the at least one of the document specific process map comprises means for providing a document-specific process map of the entity's existing document handling and delivery system and a document specific process map for at least a portion of the image-based document handling and delivery system.

23. The means of claim 21 wherein the document specific process maps comprise at least one of a group including of a new application processing map, a pull and attach document processing map, and a delivery requirements processing map.

24. The means of claim 21 wherein the means for providing the location specific process map comprises means for providing at least one of a group including a mail and copy room process map, a sales team process map, a branch team process map and an image team process map.

25. The means of claim 24 wherein the means for providing the image team process map comprises means for providing at least one of a group including of a document imaging process map, an image work flow process map, a policy building process map and an image error resolution process map.

26. The means of claim 21 wherein the location specific process map comprises providing a location specific process map of the entity's existing document handling and delivery system and a location specific process map for at least a portion of the image-based document handling and delivery system.

27. Means for implementing an image-based document handling and delivery system, comprising the steps of:
gathering information about an entity's existing document handling and delivery system;
providing the entity with at least one process map for executing the image-based document handling and delivery system; and
providing the entity with a plurality of guidelines and procedures for monitoring and maintaining performance of the image-based document handling and delivery system;
wherein the step of providing the procedures for monitoring and maintaining performance of the executed image-based document handling and delivery system includes providing a plurality of quality review procedures.

28. The means of claim 27 wherein the step of providing the quality review procedures includes providing at least one quality review form for indicating quality problems.

29. The means of claim 27 wherein the step of providing the quality review procedures includes providing a quality review error log for recording image-related errors.

30. The means of claim 29 wherein the image-related errors comprise at least one of a group including a plurality of agent related errors, a plurality of preparation related errors, a plurality of barcode-related errors, and scanning related errors.

31. A computer readable medium, the computer readable medium storing computer readable code executable to perform a method for implementing an image-based document handling and delivery system, the method comprising the steps of:
gathering information about an entity's existing document handling and delivery system;
providing the entity with at least one process map for executing the image-based document handling and delivery system; and
providing the entity with a plurality of guidelines and procedures for monitoring and maintaining performance of the image-based document handling and delivery system;
wherein the step of providing the entity with at least one process map includes providing one of a document specific process map dependent on a type of document being processed and a location specific process map dependent on a location where the document is being processed.

32. A computer readable medium, the computer readable medium storing computer readable code executable to perform a method for implementing an image-based document handling and delivery system, the method comprising the steps of:
gathering information about an entity's existing document handling and delivery system;
providing the entity with at least one process map for executing the image-based document handling and delivery system; and
providing the entity with a plurality of guidelines and procedures for monitoring and maintaining performance of the image-based document handling and delivery system;
wherein the step of providing the entity with the plurality of guidelines and procedures for monitoring and maintaining performance of the executed image-based document handling and delivery system includes providing a plurality of quality review procedures.
